(19) United States
(12) Patent Application Publication
(10) Pub. No.: US 2024/0005150 A1
(43) Pub. Date: Jan. 4, 2024

(54) EXPLAINABLE MACHINE-LEARNING MODELING USING WAVELET PREDICTOR VARIABLE DATA

(71) Applicant: EQUIFAX INC., Atlanta, GA (US)

(72) Inventors: Jeffery DUGGER, Atlanta, GA (US); Terry WOODFORD, Kennesaw, GA (US); Howard H. Hamilton, Atlanta, GA (US); Michael MCBURNETT, Cumming, GA (US); Stephen MILLER, Guiseley, Leeds (GB)

(21) Appl. No.: 18/252,660

(22) PCT Filed: Nov. 11, 2021
(86) PCT No.: PCT/US2021/072359

§ 371 Date: May 11, 2023

Related U.S. Application Data
(60) Provisional application No. 63/113,174, filed on Nov. 12, 2020.

(51) Int. Cl. G06N 3/08; G06N 5/022

(52) U.S. Cl. CPC G06N 3/08; G06N 5/022

(57) ABSTRACT

A host computing system determines a wavelet transform that represents time-series values of predictor data samples. The host computing system applies the wavelet transform to the predictor data samples to generate wavelet predictor variable data comprising a first set and a second set of shift value input data for a first scale and a second scale. The host computing system computes a set of probabilities for a target event by applying a set of timing-prediction models to the first set and the second set of shift value input data. The host computing system determines an event prediction from the set of probabilities and modifies a host system operation based on the determined event prediction.

### CROSS REFERENCE TO RELATED APPLICATIONS

This claims priority to U.S. Provisional Application No. 63/113,174, entitled “Training or Using Sets of Explainable Machine-Learning Modeling Algorithms for Predicting Timing of Events from Time Series Data Using Wavelet Predictor Variable Data,” filed on Nov. 12, 2020, which is hereby incorporated in its entirety by this reference.

### TECHNICAL FIELD

The present disclosure relates generally to artificial intelligence. More specifically, but not by way of limitation, this disclosure relates to systems that can use wavelet-based machine-learning modeling algorithms for predictions that can impact machine-implemented operating environments.

### BACKGROUND

In machine learning, machine-learning modeling algorithms can be used to perform one or more functions (e.g., acquiring, processing, analyzing, and understanding various inputs in order to produce an output that includes numerical or symbolic information). For instance, machine-learning techniques can involve using computer-implemented models and algorithms (e.g., a convolutional neural network, a support vector machine, etc.) to simulate human decision-making. In one example, a computer system programmed with a machine-learning model can learn from training data and thereby perform a future task that involves circumstances or inputs similar to the training data. Such a computing system can be used, for example, to recognize certain individuals or objects in an image, to simulate or predict future actions by an entity based on a pattern of interactions to a given individual, etc.

### SUMMARY

The present disclosure describes techniques for training and applying a set of multiple modeling algorithms to predictor variable data and thereby estimating a time period in which a target event (e.g., an adverse action) of interest will occur. For example, a host computing system accesses predictor data samples in a data repository. The host computing system generates wavelet predictor variable data by at least, applying a wavelet transform to the time-series values of the predictor variables in the predictor data samples, the wavelet predictor variable data comprising a first set of shift value input data for a first scale and a second set of shift value input data for a second scale. The host computing system computes a set of probabilities for a target event by applying a set of timing-prediction models associated with respective time windows to the first set of shift value input data and the second set of shift value input data, wherein each timing-prediction model of the set of timing-prediction models is configured to generate a respective probability of the set of probabilities indicating a probability of the target event occurring in a time window associated with the timing-prediction model. The host computing system computes an event prediction from the set of probabilities. The host computing system causes a host system operation to be modified based on the computed event prediction.

Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 is a block diagram depicting an example of a computing system in which a development computing system trains timing-prediction models that are used by one or more host computing systems, according to certain embodiments disclosed herein.

FIG. 2 depicts examples of bar graphs that illustrate modeling approaches for a time-to-event analysis performed by executing timing-prediction model code, according to certain embodiments disclosed herein.

FIG. 3 depicts an example of a process 300 for training a set of multiple modeling algorithms and thereby estimating a time period in which a target event will occur, according to certain embodiments disclosed herein.

FIG. 4 depicts simulated data distributions for predictor values, according to certain embodiments disclosed herein.

FIG. 5 depicts a performance of overlapping survival models on monthly time bins, according to certain embodiments disclosed herein.

FIG. 6 depicts a relationship between a model target variable, time to default, and a possible predictor variable, such as a risk assessment score, according to certain embodiments disclosed herein.

FIG. 7 depicts an example of Kaplan-Meier estimates of a survival function using ranges of a risk assessment score that are constructed from a regression tree model, according to certain embodiments disclosed herein.

FIG. 8 depicts an example of a table of a portion of stacked panel data constructed from multiple archives for every account for a set of entities, according to certain embodiments disclosed herein.

FIG. 9 depicts a single attribute derived from panel data such as the panel data illustrated in FIG. 8, as time-series data, according to certain embodiments disclosed herein.

FIG. 10(a) depicts a select subset of Haar wavelets at various scales and shifts based on the time-series data of FIG. 9, according to certain embodiments disclosed herein.

FIG. 10(b) depicts the account balance time-series of FIG. 9 with an approximation constructed from the basis subset of Haar wavelets shown in FIG. 10(a), according to certain embodiments disclosed herein.

FIG. 11 depicts an example of a wavelet basis set matrix comprised of Haar wavelets from FIGS. 10(a) and 10(b), according to certain embodiments disclosed herein.

FIG. 12 illustrates a generation of a wavelet predictor variable data table by multiplying stacked panel data by a flipped wavelet basis set matrix, according to certain embodiments disclosed herein.

FIG. 13(a) depicts wavelet coefficients for given subset of wavelet functions, according to certain embodiments disclosed herein.

FIG. 13(b) depicts a first wavelet coefficient for an average balance over an entire 32-month window, according to certain embodiments disclosed herein.

FIG. 13(c) depicts a second wavelet coefficient for a scaled version of a difference of average balance over a last 16 months and a previous 16 months, according to certain embodiments disclosed herein.

FIG. 13(d) depicts a third wavelet coefficient for a scaled version of a difference of an average balance over a last 8 months and a previous 8 months, according to certain embodiments disclosed herein.

FIG. 14 depicts a standard logistic regression model built using a wavelet predictor variable data table generated as in FIG. 12, according to certain embodiments disclosed herein.

FIG. 15(a) depicts an example of a survival function approximation using four binary logistic regression models, according to certain embodiments disclosed herein.

FIG. 15(b) depicts nested intervals on the underlying data of FIG. 15(a) corresponding to different definitions of “bad” depending on the time interval for a given model, according to certain embodiments disclosed herein.

FIG. 16 depicts applying inputs derived from the wavelet predictor variable data table of FIG. 12 to the nested-interval survival analysis model of FIG. 15(a), according to certain embodiments disclosed herein.

FIG. 17 depicts a vector of wavelet predictor variable data, which is generated by a matrix-vector multiplication of the Haar wavelet transform matrix depicted in FIG. 11 with a single original time-series attribute, according to certain embodiments disclosed herein.

FIG. 18 depicts a simplified example of a generic zero-overlap wavelet transform, according to certain embodiments disclosed herein.

FIG. 19 depicts an example in which multiple attributes are handled by creating a matrix where each column represents an individual attribute, according to certain embodiments disclosed herein.

FIG. 20 depicts an example in which a single row of wavelet-transformed attributes for each consumer can be created by peeling off each column in the resulting matrix, transposing each column into a row vector, and then concatenating each row to generate a concatenated row vector, according to certain embodiments disclosed herein.

FIG. 21 depicts the wavelet transform matrix from FIG. 11, according to certain embodiments disclosed herein.

FIG. 22 depicts an example of generating a submatrix having 32 shift values for scale value j=2, where the submatrix is generated using the wavelet transform matrix of FIG. 21, according to certain embodiments disclosed herein.

FIG. 23 depicts a matrix of wavelet predictor variable data, according to certain embodiments disclosed herein.

FIG. 24 depicts a panel of wavelet-transformed attributes for the consumer created from the matrix of FIG. 23, according to certain embodiments disclosed herein.

FIG. 25 depicts an example of a process for handling missing time series information when using wavelets to create new attributes from time-series data, according to certain embodiments disclosed herein.

FIG. 26(a) depicts a time series with missing values, according to certain embodiments disclosed herein.

FIG. 26(b) depicts generating a missing indicator based on the time series of FIG. 26(a), according to certain embodiments disclosed herein.

FIG. 27 depicts summation operations for several wavelets with missing values, according to certain embodiments disclosed herein.

FIG. 28(a) depicts wavelet coefficients determined by applying a Haar Wavelet Transform to the time-series of FIG. 26(a), according to certain embodiments disclosed herein.

FIG. 28(b) depicts coefficient confidence values computed based on summations determined in FIG. 27 and which correspond to the wavelet coefficients of FIG. 28(a), according to certain embodiments disclosed herein.

FIG. 29 depicts an example of a process 2900 for generating a points lost value for a timing prediction model, according to certain embodiments disclosed herein.

FIG. 30 depicts an example of a process 3000 for determining allocations of score values for a timing prediction model using an integrated gradients approach, according to certain embodiments disclosed herein.

FIG. 31 depicts an example of a process 3100 for determining Shapley value contributions for a timing prediction model, according to certain embodiments disclosed herein.

FIG. 32 is a block diagram depicting an example of a computing system that can be used to implement one or more of the systems depicted in FIG. 1, according to certain embodiments disclosed herein.

### DETAILED DESCRIPTION

Certain aspects and features of the present disclosure involve training and applying a set of multiple modeling algorithms to predictor variable data and thereby estimating a time period in which a target event (e.g., an adverse action) of interest will occur. An automated modeling system can receive time series data (e.g. panel data) that includes values for multiple attributes describing an entity. The time series data includes, for each attribute, attribute values at multiple time instances over a time window. The automated modeling system can apply a wavelet transform to time series data to generate wavelet predictor variable data for a model. For time series data that has missing values for one or more time instances, the automated modeling system may account for the missing values in the wavelet predictor variable data by augmenting wavelet transform coefficients in the wavelet predictor variable data with coefficient confidence values. The automated modeling system can apply the model to wavelet predictor variable data to generate an adverse action prediction. The automated modeling system can provide explanatory data to explain or otherwise account for the adverse action prediction given by the model by applying a points below value approach, an integrated gradients approach, or a Shapley values approach. By using wavelet predictor variable data, the prediction accuracy of the modeling algorithms can be improved.

In some aspects, the modeling algorithms can use, as input, a set of wavelet predictor variable data generated from time series data. Modeling algorithms include, for example, binary prediction algorithms that involve models such as neural networks, support vector machines, logistic regression, etc. Each modeling algorithm can be trained to predict, for example, an adverse action based on data from a particular time bin within a time window encompassing multiple periods. An automated modeling system can use the set of modeling algorithms to perform a variety of functions including, for example, utilizing various independent variables and computing an estimated time period in which a predicted response, such as an adverse action or other target event, will occur. This timing information can be used to modify a machine-implemented operating environment to account for the occurrence of the target event.

For instance, an automated modeling system can apply different modeling algorithms to the wavelet predictor variable data in a given observation period to predict (either directly or indirectly) the presence of an event in different time bins encompassed by a performance window. In some aspects, a probability of the event's occurrence can be computed either directly from a timing-prediction model in the modeling algorithm or derived from the timing-prediction model's output. If a modeling algorithm for a particular time bin is used to compute the highest probability of the adverse event, the automated modeling system can select that particular time bin as the estimated time period in which the predicted response will occur.

In some aspects, a model-development environment can train the set of modeling algorithms. The model-development environment can generate the set of machine-learning models from a set of training data for a particular training window, such as a 24-month period for which training data is available. The training window (performance window) can include multiple time bins, where each time bin is a time period and data samples representing observations occurring in that time period are assigned to that time bin (i.e., indexed by time bin). In a simplified example, a training window includes at least two time bins. The model-development environment trains a first modeling algorithm, which involves a machine-learning model, to predict a timing of an event in the first time bin based on the training data. The model-development environment trains a second modeling algorithm, which also involves a machine-learning model, to predict a timing of an event in the second time bin based on the training data. In some aspects, the second time bin can encompass or otherwise overlap the first time. For instance, the first time bin can include the first three months of the training window, and the second time bin can include the first six months of the training window. In additional or alternative aspects, the model-development environment enforces a monotonicity constraint on the training process for each machine-learning model in each time bin. In the training process, the model-development environment trains each machine-learning model to compute the probability of an adverse action occurring if a certain set of predictor variable values (e.g., consumer attribute values, wavelet predictor variable values) are encountered.

Continuing with this example, the model-development environment can apply the trained set of models to compute an estimated timing of an adverse action. For instance, the model-development environment can receive time series data for a given entity. For instance, the time series data is panel data that includes data describing attributes for accounts of the given entity over particular time periods. The panel data can be compiled from raw tradeline data for multiple entities. The model-development environment determines a wavelet transform to represent the time series data and determines wavelet predictor variable data using the wavelet transform and the time series data. A set of time series data can be represented as a weighted set of scaled and shifted basis functions. The set of coefficients (i.e., the weights) is a wavelet transform of that time series data. That set of coefficients are the input data (i.e., the wavelet predictor variable data) for a modeling process described herein. For instance, the wavelet predictor variable data includes, for each scale of the Haar wavelet, a set of coefficient values corresponding to each shift. The model-development environment can compute a first adverse action probability for each scale of the wavelet predictor variable data. For instance, the model-development environment computes a first adverse action probability for a scale by applying the first machine-learning model to predictor variable values that include a corresponding set of shift values for the scale. For instance, the first adverse action probability, which is generated from the training data in a three-month period from the training window, can indicate a probability of an adverse action occurring within the first three months of a target window. The model-development environment can compute a second adverse action probability for each scale of the wavelet predictor variable data. For instance, the model-development environment computes a second adverse action probability for a scale by applying the second machine-learning model to predictor variable values that include a corresponding set of shift values for the scale. For instance, the second adverse action probability, which is generated from the training data in a six-month period from the training window, can indicate a probability of an adverse action occurring within the second six months of a target window. The model-development environment determines a first adverse action probability as a function (e.g. an average) of the respective first adverse action probabilities computed for each of the scales of the wavelet predictor variable data and determines a second adverse action probability as a function (e.g. an average) of the respective first adverse action probabilities computed for each of the scales of the wavelet predictor variable data. The model-development environment can determine that the second adverse action probability is greater than the first adverse action probability. The model-development environment can output, based on the second adverse action probability being greater than the first adverse action probability, an adverse action timing prediction. The adverse action timing prediction can indicate that an adverse action will occur after the first three months of the target window and before the six-month point in the target window.

Continuing with this example, in some instances, the model-development environment can generate wavelet variable predictor data from time series data for the given entity that is missing one or more values. The model-development environment can generate a missing data value indicator by assigning, for each time instance of the time series, a value of one (1) to time instances that are missing data values and a value of zero (0) to time instances that have data values. The model-development environment can determine coefficient confidence values corresponding to wavelet scales and shifts. For example, the model-development environment can create summation operations that cover windows of time corresponding to the scale and shift of the wavelet transform applied to the time series waveform and determine a fraction for each window. The fraction for each window includes a resulting summation for the numerator and a number of non-zero values in the corresponding wavelet transform for the denominator. The model-development environment can subtract the fractions from a value of one (1) to yield coefficient confidence values that correspond to the wavelet coefficients for the time series data. The model-development environment can generate the wavelet predictor variable data by augmenting the wavelet transform coefficients with the coefficient confidence values.

Continuing with this example, the model-development environment can generate explanatory data for the adverse action timing prediction. For example, the model-development environment can construct a set of predictor attributes from the wavelet coefficients that allow an explanation of various influences on an adverse action timing prediction. The model-development environment can generate parameter values for each wavelet coefficient. The parameter values may include model coefficients and weights. The model development environment can score the set of wavelet coefficient predictor data using these parameter values to produce an entity's adverse action timing prediction or other types of predictions (e.g. a score). The model development environment can determine the direction of effect of each original attribute and each wavelet coefficient with respect to probability of the adverse action timing prediction. In effect, the collective impact of the wavelet coefficients on probability of adverse action can replicate the original attribute's direction of effect with regard to probability of adverse action. A machine learning model using wavelets with parameter values that are statistically significant and in agreement with the exploratory data analysis (EDA) can produce the entity's adverse action timing prediction (e.g. the entity's original score).

Certain aspects can include operations and data structures with respect to neural networks or other models that improve how computing systems service analytical queries or otherwise update machine-implemented operating environments. For instance, a particular set of rules are employed in the training of timing-prediction models that are implemented via program code. This particular set of rules allow, for example, different models to be trained over different timing windows, for monotonicity to be introduced as a constraint in the optimization problem involved in the training of the models, or both. Employment of these rules in the training of these computer-implemented models can allow for more effective prediction of the timing of certain events, which can in turn facilitate the adaptation of an operating environment based on that timing prediction (e.g., modifying an industrial environment based on predictions of hardware failures, modifying an interactive computing environment based on risk assessments derived from the predicted timing of adverse events, etc.). Thus, certain aspects can effect improvements to machine-implemented operating environments that are adaptable based on the timing of target events with respect to those operating environments.

Certain aspects described herein improve how computing systems represent time series data for input to machine-learning models. For instance, the methods described herein for handling missing data in time series can generate a set of wavelet predictor variable data by augmenting wavelet transform coefficients with coefficient confidence values. Employment of methods described herein to handle missing data in time series to these computer-implemented models can allow for more effective prediction of the timing of certain events, which can in turn facilitate the adaptation of an operating environment based on that timing prediction (e.g., modifying an industrial environment based on predictions of hardware failures, modifying an interactive computing environment based on risk assessments derived from the predicted timing of adverse events, etc.). Thus, certain aspects can effect improvements to machine-implemented operating environments that are adaptable based on the timing of target events with respect to those operating environments.

Certain aspects described herein improve how computing systems explain outputs of machine-learning models. For instance, the approaches described herein (e.g. points below maximum, integrated gradients, and Shapley values approaches) can determine an effect of individual wavelet inputs, of a set of wavelets that represent an input time series, on an adverse event prediction output by a machine-learning model. Employment of such approaches can allow for a clearer or more accurate explanation of model predictions over conventional approaches when the models described herein are applied to wavelet variable input data.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

Example of a Computing Environment for Implementing Certain Aspects

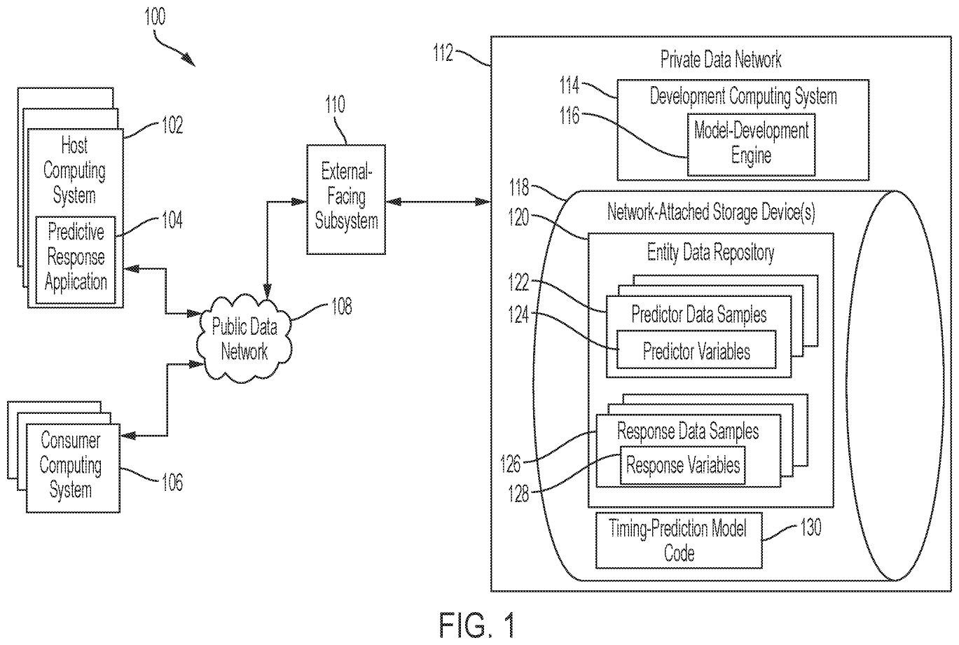

Referring now to the drawings, FIG. 1 is a block diagram depicting an example of a computing system 100 in which a development computing system 114 trains timing-prediction models that are used by one or more host computing systems. FIG. 1 depicts examples of hardware components of a computing system 100, according to some aspects. The numbers of devices depicted in FIG. 1 are provided for illustrative purposes. Different numbers of devices may be used. For example, while various elements are depicted as single devices in FIG. 1, multiple devices may instead be used.

The computing system 100 can include one or more host computing systems 102. A host computing system 102 can communicate with one or more of a consumer computing system 106, a development computing system 114, etc. For example, a host computing system 102 can send data to a target system (e.g., the consumer computing system 106, the development computing system 114 etc.) to be processed. The host computing system 102 may send signals to the target system to control different aspects of the computing environment or the data it is processing, or some combination thereof. A host computing system 102 can interact with the development computing system 114, the consumer computing system 106, or both via one or more data networks, such as a public data network 108.

A host computing system 102 can include any suitable computing device or group of devices, such as (but not limited to) a server or a set of servers that collectively operate as a server system. Examples of host computing systems 102 include a mainframe computer, a grid computing system, or other computing system that executes an automated modeling algorithm, which uses timing-prediction models with learned relationships between independent variables and the response variable. For instance, a host computing system 102 may be a host server system that includes one or more servers that execute a predictive response application 104 and one or more additional servers that control an operating environment. Examples of an operating environment include (but are not limited to) a website or other interactive computing environment, an industrial or manufacturing environment, a set of medical equipment, a power-delivery network, etc. In some aspects, one or more host computing systems 102 may include network computers, sensors, databases, or other devices that may transmit or otherwise provide data to the development computing system 114. For example, the host computing devices 102a-c may include local area network devices, such as routers, hubs, switches, or other computer networking devices.

In some aspects, the host computing system 102 can execute a predictive response application 104, which can include or otherwise utilize timing-prediction model code 130 that has been optimized, trained, or otherwise developed using the model-development engine 116, as described in further detail herein. In additional or alternative aspects, the host computing system 102 can execute one or more other applications that generate a predicted response, which describes or otherwise indicate a predicted behavior associated with an entity. Examples of an entity include a system, an individual interacting with one or more systems, a business, a device, etc. These predicted response outputs can be computed by executing the timing-prediction model code 130 that has been generated or updated with the model-development engine 116.

The computing system 100 can also include a development computing system 114. The development computing system 114 may include one or more other devices or sub-systems. For example, the development computing system 114 may include one or more computing devices (e.g., a server or a set of servers), a database system for accessing the network-attached storage devices 118, a communications grid, or both. A communications grid may be a grid-based computing system for processing large amounts of data.

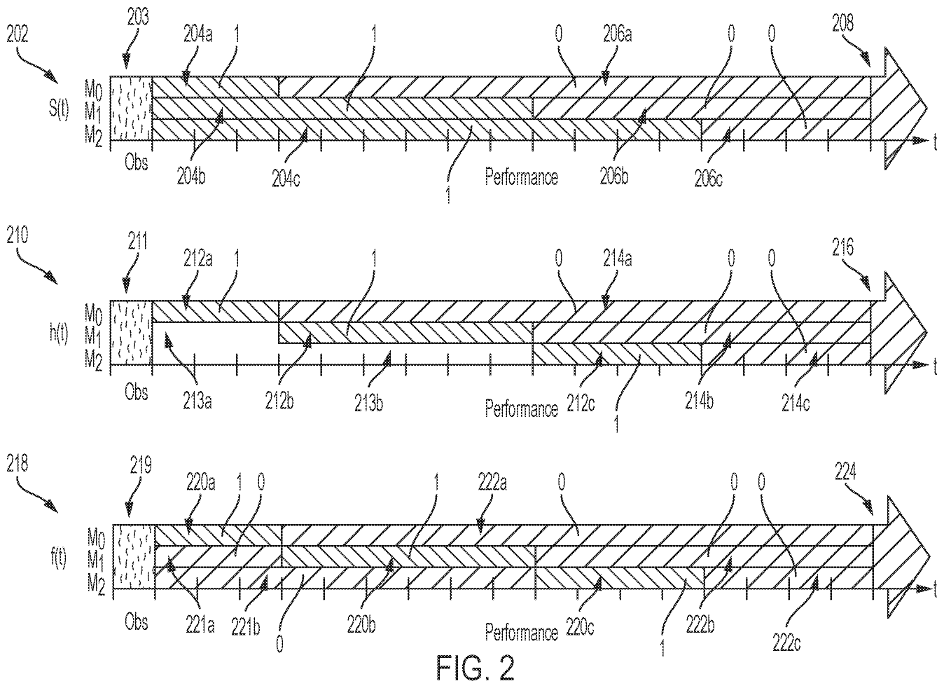

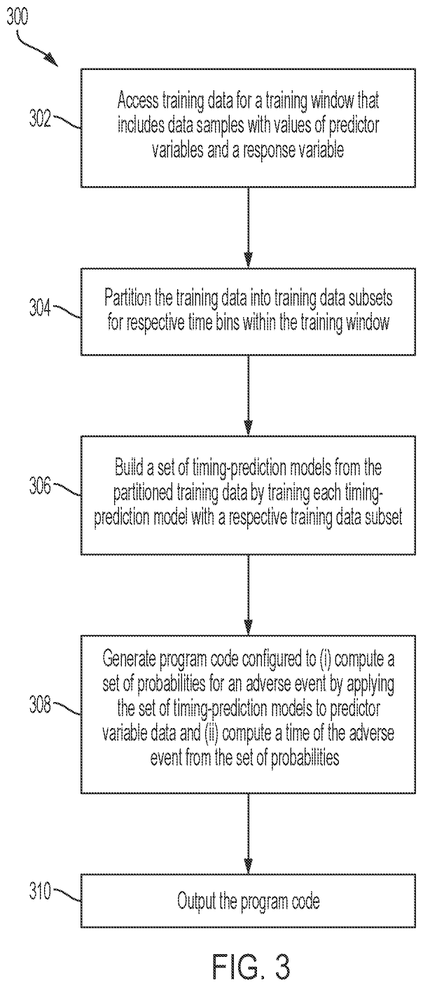

The development computing system 114 can include one or more processing devices that execute program code stored on a non-transitory computer-readable medium. The program code can include a model-development engine 116. Timing-prediction model code 130 can be generated or updated by the model-development engine 116 using the predictor data samples 122 and the response data samples 126. For instance, as described in further detail with respect to the examples of FIGS. 2 and 3, the model-development engine 116 can use the predictor data samples 122 and the response data samples 126 to learn relationships between predictor variables 124 and one or more response variables 128.

The model-development engine 116 can generate or update the timing-prediction model code 130. The timing-prediction model code 130 can include program code that is executable by one or more processing devices. The program code can include a set of modeling algorithms. A particular modeling algorithm can include one or more functions for accessing or transforming input wavelet predictor variable data, such as a set of shift values for a particular individual or other entity for each scale of a set of scales, one or more functions for computing scale-specific probabilities of a target event, such as an adverse action or other event of interest, and one or more functions for computing a combined probability of the target event from the computed scale-specific probabilities. In another example, the particular modeling algorithm can include one or more functions for accessing or transforming input wavelet predictor variable data, such as a set of shift values for a particular individual or other entity for each scale of a set of scales, one or more functions for computing a set of probabilities of a target event, such as an adverse action or other event of interest, and one or more functions for determining an event prediction from the set of probabilities. Functions for computing the probability of target events can include, for example, applying a trained machine-learning model or other suitable model to the wavelet coefficients. The trained machine-learning model can be a binary prediction model. In certain examples, the functions for computing the probability of the target event include applying the trained machine-learning model to each set of shift values of the set of wavelet coefficients to determine a set of probabilities and determining the event prediction as a function of (e.g. an average of) the set of probabilities. In other examples, the functions for computing the probability of the target event include applying the trained machine-learning model to each set of shift values of the set of wavelet coefficients to determine a respective scale-specific probability and determining the probability of the target event as a function (e.g. an average) of the determined scale-specific probabilities. The trained model in these examples can be a tree-based model. In other examples, the functions for computing the probability of the target event include preprocessing the set of wavelet coefficients to determine, from the sets of shift values of the wavelet coefficients, a single set of values and applying the trained machine-learning model to the single set of values to determine the probability of the target event. The program code includes one or more functions for identifying, for each entity, a respective set of rows corresponding to separate shifts in the panel and concatenating the identified set of rows into a single row. The trained model in these other examples can be a logistic regression model or a neural network model. The program code for computing the probability of the target event can include model structures (e.g., layers in a neural network) and model parameter values (e.g., weights applied to nodes of a neural network, etc.).

The development computing system 114 may transmit, or otherwise provide access to, timing-prediction model code 130 that has been generated or updated with the model-development engine 116. A host computing system 102 can execute the timing-prediction model code 130 and thereby compute an estimated time of a target event. The timing-prediction model code 130 can also include program code for computing a timing, within a target window, of an adverse action or other event based on the probabilities from various modeling algorithms that have been trained using the model-development engine 116 and historical predictor data samples 122 and response data samples 126 used as training data.

For instance, computing the timing of an adverse action or other events can include identifying which of the modeling algorithms were used to compute the highest probability for the adverse action or other event. Computing the timing can also include identifying a time bin associated with one of the modeling algorithms that was used to compute the highest probability value (e.g., the first three months, the first six months, etc.). The associated time bin can be the time period used to train the model implemented by the modeling algorithm. The associated time bin can be used to identify a predicted time period, in a subsequent target window for a given entity, in which the adverse action or other events will occur. For instance, if a modeling algorithm has been trained using data in the first three months of a training window, the predicted time period can be between zero and three months of a target window (e.g., defaulting on a loan within the first three months of the loan).

The computing system 100 may also include one or more network-attached storage devices 118. The network-attached storage devices 118 can include memory devices for storing an entity data repository 120 and timing-prediction model code 130 to be processed by the development computing system 114. In some aspects, the network-attached storage devices 118 can also store any intermediate or final data generated by one or more components of the computing system 100.

The entity data repository 120 can store predictor data samples 122 and response data samples 126. The predictor data samples 122 can include values of one or more predictor variables 124. The external-facing subsystem 110 can prevent one or more host computing systems 102 from accessing the entity data repository 120 via a public data network 108. The predictor data samples 122 and response data samples 126 can be provided by one or more host computing systems 102 or consumer computing systems 106, generated by one or more host computing systems 102 or consumer computing systems 106, or otherwise communicated within a computing system 100 via a public data network 108.

For example, a large number of observations can be generated by electronic transactions, where a given observation includes one or more predictor variables (or data from which a predictor variable can be computed or otherwise derived). A given observation can also include data for a response variable or data from which a response variable value can be derived. Examples of predictor variables can include data associated with an entity, where the data describes behavioral or physical traits of the entity, observations with respect to the entity, prior actions or transactions involving the entity (e.g., information that can be obtained from credit files or records, financial records, consumer records, or other data about the activities or characteristics of the entity), or any other traits that may be used to predict the response associated with the entity. In some aspects, samples of predictor variables, response variables, or both can be obtained from credit files, financial records, consumer records, etc.

Network-attached storage devices 118 may also store a variety of different types of data organized in a variety of different ways and from a variety of different sources. For example, network-attached storage devices 118 may include storage other than primary storage located within development computing system 114 that is directly accessible by processors located therein. Network-attached storage devices 118 may include secondary, tertiary, or auxiliary storage, such as large hard drives, servers, virtual memory, among other types. Storage devices may include portable or non-portable storage devices, optical storage devices, and various other mediums capable of storing or containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as compact disk or digital versatile disk, flash memory, memory or memory devices.

In some aspects, the host computing system 102 can host an interactive computing environment. The interactive computing environment can receive a set of raw tradeline data. The interactive computing environment can determine time series data (e.g. panel data) from raw tradeline data, determine a wavelet transform that describes the time-series data, and generate a set of wavelet predictor variable data using the time series data and the wavelet transform. The set of wavelet predictor variable data is used as input to the timing-prediction model code 130. The host computing system 102 can execute the timing-prediction model code 130 using the set of wavelet predictor variable data. The host computing system 102 can output an estimated time of an adverse action (or other events of interest) that is generated by executing the timing-prediction model code 130.

In additional or alternative aspects, a host computing system 102 can be part of a private data network 112. In these examples, the host computing system 102 can communicate with a third-party computing system that is external to the private data network 112 and that hosts an interactive computing environment. The third-party system can receive, via the interactive computing environment, a set of time-series data for an entity. The third-party system can provide the set of time-series data to the host computing system 102. The host computing system 102 can determine a wavelet transform that represents the time-series data, and generate a set of wavelet predictor variable data using the wavelet transform and the time-series data. In other examples, the third-party system can generate the set of wavelet predictor variable data and the host computing system 102 can receive the set of wavelet predictor variable data from the third-party system. The host computing system 102 can execute the timing-prediction model code 130 using the set of wavelet predictor variable data. The host computing system 102 can transmit, to the third-party system, an estimated time of an adverse action (or other events of interest) that is generated by executing the timing-prediction model code 130.

A consumer computing system 106 can include any computing device or other communication device operated by a user, such as a consumer or a customer. The consumer computing system 106 can include one or more computing devices, such as laptops, smart phones, and other personal computing devices. A consumer computing system 106 can include executable instructions stored in one or more non-transitory computer-readable media. The consumer computing system 106 can also include one or more processing devices that are capable of executing program code to perform operations described herein. In various examples, the consumer computing system 106 can allow a user to access certain online services from a consumer computing system 106, to engage in mobile commerce with a consumer computing system 106, to obtain controlled access to electronic content hosted by the consumer computing system 106, etc.

Communications within the computing system 100 may occur over one or more public data networks 108. In one example, communications between two or more systems or devices can be achieved by a secure communications protocol, such as secure sockets layer (“SSL”) or transport layer security (“TLS”). In addition, data or transactional details may be encrypted. A public data network 108 may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or combination of wireless interfaces. A wired network may include a wired interface. The wired or wireless networks may be implemented using routers, access points, bridges, gateways, or the like, to connect devices in a data network.

The computing system 100 can secure communications among different devices, such as host computing systems 102, consumer computing systems 106, development computing systems 114, host computing systems 102, or some combination thereof. For example, the client systems may interact, via one or more public data networks 108, with various one or more external-facing subsystems 110. Each external-facing subsystem 110 includes one or more computing devices that provide a physical or logical subnetwork (sometimes referred to as a “demilitarized zone” or a “perimeter network”) that expose certain online functions of the computing system 100 to an untrusted network, such as the Internet or another public data network 108.

Each external-facing subsystem 110 can include, for example, a firewall device that is communicatively coupled to one or more computing devices forming a private data network 112. A firewall device of an external-facing subsystem 110 can create a secured part of the computing system 100 that includes various devices in communication via a private data network 112. In some aspects, as in the example depicted in FIG. 1, the private data network 112 can include a development computing system 114, which executes a model-development engine 116, and one or more network-attached storage devices 118, which can store an entity data repository 120. In additional or alternative aspects, the private data network 112 can include one or more host computing systems 102 that execute a predictive response application 104.

In some aspects, by using the private data network 112, the development computing system 114 and the entity data repository 120 are housed in a secure part of the computing system 100. This secured part of the computing system 100 can be an isolated network (i.e., the private data network 112) that has no direct accessibility via the Internet or another public data network 108. Various devices may also interact with one another via one or more public data networks 108 to facilitate electronic transactions between users of the consumer computing systems 106 and online services provided by one or more host computing systems 102.

In some aspects, including the development computing system 114 and the entity data repository 120 in a secured part of the computing system 100 can provide improvements over conventional architectures for developing program code that controls or otherwise impacts host system operations. For instance, the entity data repository 120 may include sensitive data aggregated from multiple, independently operating contributor computing systems (e.g., failure reports gathered across independently operating manufacturers in an industry, personal identification data obtained by or from credit reporting agencies, etc.). Generating timing-prediction model code 130 that more effectively impacts host system operations (e.g., by accurately computing timing of a target event) can require access to this aggregated data. However, it may be undesirable for different, independently operating host computing systems to access data from the entity data repository 120 (e.g., due to privacy concerns). By building timing-prediction model code 130 in a secured part of a computing system 100 and then outputting that timing-prediction model code 130 to a particular host computing system 102 via the external-facing subsystem 110, the particular host computing system 102 can realize the benefit of using higher quality timing-prediction models (i.e., model built using training data from across the entity data repository 120) without the security of the entity data repository 120 being compromised.

Host computing systems 102 can be configured to provide information in a predetermined manner. For example, host computing systems 102 may access data to transmit in response to a communication. Different host computing systems 102 may be separately housed from each other device within the computing system 100, such as development computing system 114, or may be part of a device or system. Host computing systems 102 may host a variety of different types of data processing as part of the computing system 100. Host computing systems 102 may receive a variety of different data from the computing devices 102a-c, from the development computing system 114, from a cloud network, or from other sources.

Examples of Generating Sets of Timing-Prediction Models

In one example, the model-development engine 116 can access training data that includes the predictor data samples 122 and response data samples 126. The predictor data samples 122 and response data samples 126 include, for example, entity data for multiple entities, such as entities or other individuals over different time bins within a training window. Response data samples 126 for a particular entity indicate whether or not an event of interest, such as an adverse action, has occurred within a given time period. Examples of a time bin include a month, a quarter of a performance window, a biannual period, or any other suitable time period. An example of an event of interest is a default, such as being 90+ days past due on a specific account.

If the response data samples 126 for an entity indicate the occurrence of the event of interest in a particular time bin (e.g., a month), the model-development engine 116 can count the number of time bins (e.g., months) until the first time the event occurs in the training window. The model-development engine 116 can assign, to this entity, a variable t equal to the number of time bins (months). The performance window can have a defined starting time such as, for example, a date an account was opened, a date that the entity defaults on a separate account, etc. The performance window can have a defined ending time, such as 24 months after the defined starting time. If the response data samples 126 for an entity indicate the non-occurrence of the event of interest in the training window, the model-development engine 116 can set t to any time value that occurs beyond the end of the training window.

The model-development engine 116 can select predictor variables 124 in any suitable manner. In some aspects, the model-development engine 116 can add, to the entity data repository 120, predictor data samples 122 with values of one or more predictor variables 124. One or more predictor variables 124 can correspond to one or more attributes measured in an observation window, which is a time period preceding the performance window. For instance, predictor data samples 122 can include values indicating actions performed by an entity or observations of the entity. The observation window can include data from any suitable time period. In one example, an observation window has a length of one month. In another example, an observation window has a length of multiple months.

In some aspects, training a timing-prediction model used by a host computing system 102 can involve ensuring that the timing-prediction model provides a predicted response, as well as an explanatory capability. Certain predictive response applications 104 require using models having an explanatory capability. An explanatory capability can involve generating explanatory data such as adverse action codes (or other reason codes) associated with independent variables that are included in the model. This explanatory data can indicate an effect, an amount of impact, or other contribution of a given independent variable with respect to a predicted response generated using an automated modeling algorithm.

The model-development engine 116 can use one or more approaches for training or updating a given modeling algorithm. Examples of these approaches can include overlapping survival models, non-overlapping hazard models, and interval probability models.

Survival analysis predicts the probability of when an event will occur. For instance, survival analysis can compute the probability of “surviving” up to an instant of time t at which an adverse event occurs. In a simplified example, survival could include the probability of remaining “good” on a credit account until time t, i.e., not being 90 days past due or worse on an account. The survival analysis involves censoring, which occurs when the event of interest has not happened for the period in which training data is analyzed and the models are built. Right-censoring means that the event occurs beyond the training window, if at all. In the example above, the right-censoring is equivalent to an entity remaining “good” throughout the training window.

Survival analysis involves a survival function, a hazard function, and a probability function. In one example, the survival function predicts the probability of the non-occurrence of an adverse action (or other event) up to a given time. In this example, the hazard function provides the rate of occurrence of the adverse action over time, which can indicate a probability of the adverse action occurring given that a particular length of time has occurred without occurrence of the adverse action. The probability function shows the distribution of times at which the adverse action occurs.

Equation (1) gives an example of a mathematical definition of a survival function:

S(tⱼ)=P(T>tⱼ) (1)

In Equation (1), tⱼ corresponds to the time period in which an entity experiences the event of interest. In a simplified example, an event of interest could be an event indicating a risk associated with the entity, such as a default on a credit account by the entity.

If the survival function is known, the hazard function can be computed with Equation (2):

$$h ( {t}_{j} ) = \frac{S ( {t}_{j - 1} ) - S ( {t}_{j} )}{S ( {t}_{j - 1} )} \qquad ( 2 )$$

If the hazard function is known, the survival function can be computed with Equation (3):

$$S ( {t}_{j} ) = {\prod }_{k = 1}^{j} [ 1 - h ( {t}_{k} ) ] \qquad ( 3 )$$

If both the hazard and survival functions are known, the probability density function can be computed with Equation (4):

ƒ(tⱼ)=h(tⱼ)S(tⱼ₋₁) (4)

The overlapping survival approach involves building the set of models on overlapping time intervals. The non-overlapping hazard approach approximates the hazard function with a set of constant hazard rates in different models on disjoint time intervals. The interval probability approach estimates the probability function directly. Time intervals can be optimally selected in these various approaches.

For instance, in each approach, the model-development engine 116 can partition a training window into multiple time bins. For each time bin, the model-development engine 116 can generate, update, or otherwise build a corresponding model to be included in the timing-prediction model code 130. Any suitable time period can be used in the partition of the training window. A suitable time period can depend on the resolution of response data samples 126. A resolution of the data samples can include a granularity of the time stamps for the response data samples 126, such as whether a particular data sample can be matched to a given month, day, hour, etc. The set of time bins can span the training window.

FIG. 2 depicts examples of bar graphs that illustrate modeling approaches for a time-to-event analysis performed by executing timing-prediction model code 130. For instance, an overlap survival approach is represented using the bar graph 202, a non-overlap hazard approach is represented using the bar graph 210, and an interval probability approach is represented using the bar graph 218.

In this example, the model-development engine 116 can be used to build three models (M₀, M₁, M₂) for each approach: S(t), h(t), ƒ(t). Each model can be a binary prediction model predicting whether a response variable will have an output of 1 or 0. The target variable definition can change for each model depending on the approach used. A “1” indicates the entity experienced a target event in a period. For instance, in the bar graph 202 representing a performance window using the overlap survival approach, a “1” value indicating an event's occurrence is included in periods 204a, 204b, and 204c. Similarly, in the bar graph 210 representing a performance window using the non-overlap hazard approach, a “1” value indicating an event's occurrence is included in periods 212a, 212b, and 212c. And in the bar graph 218 representing a performance window using the interval probability approach, a “1” value indicating an event's occurrence is included in periods 220a, 220b, and 220c.

In the examples of FIG. 2, a “0” indicates the entity did not experience the event within the time period. For instance, in the bar graph 202 representing the overlap survival approach, a “0” value indicating an event's non-occurrence is included in periods 206a, 206b, and 206c. Similarly, in the bar graph 210 representing the non-overlap hazard approach, a “0” value indicating an event's non-occurrence is included in periods 214a, 214b, and 214c. And in the bar graph 218 representing the interval probability approach, a “0” value indicating an event's non-occurrence is included in periods 221a, 221b, 222a, 222b, and 222c. In the bar graphs 202, 210, and 218, the respective arrows 208, 216, and 224 pointing towards the right indicates inclusion in the model of entities beyond the time period shown who did not experience the event within the performance window (i.e. censored data).

In these examples, the model-development engine 116 sets a target variable for each model to “1” if the value of t falls within an area visually represented by a right-and-down diagonal pattern in FIG. 2. Otherwise, the model-development engine 116 sets the target variable for each model to “0.” Assignments of “1” and “0” to the target variable for each model are illustrated in the bar graph 202 for the overlap survival method (S(t)), the bar graph 210 for the non-overlap hazard method (h(t)) and the bar graph 218 for the interval probability method (ƒ(t)). The performance window for each model contains the combined time periods indicated in right-and-down diagonal pattern and a left-and-up diagonal pattern (e.g., a combination of periods 204a and 206a in bar graph 202, a combination of periods 212a and 214a in bar graph 210, etc.). In the case of the bar graph 210 representing h(t), the time periods 213a and 213b are visually represented as white areas to indicate that no data samples for those entities for which the target event occurred within those time periods were used to build the model (e.g., samples whose values of t lie in the time period 213a were not used to build the model M₁ and samples whose values of t lie in the time period 213b were not used to build the model M₂).

The overlapping survival model can include modeling a survival function, S(t), directly rather than the underlying hazard function, h(t). In some aspects, this approach is equivalent to building timing-prediction models over various, overlapping time bins. Non-overlapping hazard models represent a step-wise approximation to the hazard function, h(t), where the hazard rate is assumed constant over each interval. In one example, the model-development engine 116 can build non-overlapping hazard models on both individual months and groups of months utilizing logistic regression on each interval independently. Interval probability models attempt to estimate the probability function directly.

The predictor variables 124 used for the model in each approach can be obtained from predictor data samples 122 having time stamps in an observation period. The observation period can occur prior to the training window. In the examples of FIG. 2, the predictor variables 124 are attributes from observation periods 203, 211, and 219, each of which is a single month that precedes the performance window.

The model-development engine 116 can build any suitable binary prediction model, such as a neural network, a standard logistic regression credit model, a tree-based machine learning model, etc. In some aspects, the model-development engine 116 can enforce monotonicity constraints on the models. Enforcing monotonicity constraints on the models can cause the models to be regulatory-compliant. Enforcing monotonicity constraints can include exploratory data analysis, binning, variable reduction, etc. For instance, binning, variable reduction, or some combination thereof can be applied to the training data and thereby cause a model built from the training data to match a predictor/response relationship identified from the exploratory data analysis.

In some aspects, performing a training process that enforces monotonicity constraints enhances computing devices that implement artificial intelligence. The artificial intelligence can allow the same timing-prediction model to be used for determining a predicted response and for generating explanatory data for the independent variables. For example, a timing-prediction model can be used for determining a level of risk associated with an entity, such as an individual or business, based on independent variables predictive of risk that is associated with an entity. Because monotonicity has been enforced with respect to the model, the same timing-prediction model can be used to compute explanatory data describing the amount of impact that each independent variable has on the value of the predicted response. An example of this explanatory data is a reason code indicating an effect or an amount of impact that a given independent variable has on the value of the predicted response. Using these timing-prediction models for computing both a predicted response and explanatory data can allow computing systems to allocate process and storage resources more efficiently, as compared to existing computing systems that require separate models for predicting a response and generating explanatory data.

In the examples depicted in FIG. 2, the models correspond to a survival probability per period for entities in the overlapping survival case, a bad rate (hazard rate) per period for entities in the non-overlapping hazard models, and a probability of bad per period for entities in the interval probability model, which allows for calculating the most probable time at which an event of interest will occur. The model-development engine 116 can use a variable T that is defined as a non-negative random variable representing the time until default occurs. The distribution of default times can be defined by a probability function, ƒ(t).

In some aspects, a value of “1” can represent an event-occurrence in the timing-prediction models. In additional or alternative aspects, the model-development engine 116 can assign a lower score to a higher probability of event-occurrence and assign a higher score to a lower probability of event-occurrence. For example, a credit score can be computed as a probability of non-occurrence of an event (“good”) multiplied by 1000, which yields higher credit scores for lower-risk entities. The effects of this choice can be seen in Equations (5), (8), and (11) below.

In the overlap survival approach in FIG. 2, the model-development engine 116 can use the estimated survival function, S(tⱼ) to compute the remaining functions of interest, including the hazard rate, h(tⱼ), and the probability function, ƒ(tⱼ). In this example, the training data set for this approach includes the entire performance window, though other implementations are possible. The index variable j is used to index the models Mⱼ. The variable tⱼ corresponds to the right-most edge of the time bin, in which it is desired to determine whether an entity experiences the event of interest, such as an adverse action (e.g., a default, a component failure, etc.). If an entity experienced the event in this time bin, then the response variable is defined to be “1”; otherwise, the response variable is defined to be “0”. A binary classification model (e.g. logistic regression) is trained to generate a scoreⱼ for the time bin specified by model Mⱼ. The value of scoreⱼ provided by the model is defined as described above (e.g., with respect to the credit score example). Examples of formulas for implementing this approach are provided in Equations (5)-(7):

$$S ( {t}_{j} ) = \frac{{score}_{j}}{1000} \qquad ( 5 )$$

$$f ( {t}_{j} ) = S ( {t}_{j - 1} ) - S ( {t}_{j} ) \qquad ( 6 )$$

$$h ( {t}_{j} ) = \frac{f ( {t}_{j} )}{S ( {t}_{j - 1} )} \qquad ( 7 )$$

For example, if j=0, a corresponding model M₀ could be built from time bin t₀ of three months, if j=1, a corresponding model M₁ could be built from time bin t₀ of six months, etc. Tabulating and plotting S(tⱼ) from a model Mⱼ yields the survival curve. From this tabulation, and defining S(t₋₁)=1, ƒ(tⱼ) and h(tⱼ) can be calculated according to Equations (6) and (7).

In the non-overlapping hazard approach, the model-development engine 116 can use the estimated hazard rate, h(tⱼ) to compute the remaining functions of interest, including the survival function, S(tⱼ), and the probability function, ƒ(tⱼ). The training data set for each model Mⱼ comprises successive subsets of the original data set. In some aspects, these subsets result from removing entities that were labeled as “1” in all prior models. The variable tⱼ corresponds to the right-most edge of the time bin, in which it is desired to determine whether an entity experiences the event of interest, such as an adverse action (e.g., a default, a component failure, etc.). If an entity experienced the event in this time bin, then the response variable is defined to be “1”; otherwise, the response variable is defined to be “0”. A binary classification model (e.g. logistic regression) is trained to generate a scoreⱼ for the time bin specified by model Mⱼ. The value of scoreⱼ provided by the model is defined as described above (e.g., with respect to the credit score example). Examples of formulas for implementing this approach are provided in Equations (8)-(10).

$$h ( {t}_{j} ) = 1 - \frac{{score}_{j}}{1000} \qquad ( 8 )$$

$$S ( {t}_{j} ) = {\prod }_{k = 1}^{j} [ 1 - h ( {t}_{k} ) ] \qquad ( 9 )$$

$$f ( {t}_{j} ) = h ( {t}_{j} ) S ( {t}_{j - 1} ) \qquad ( 10 )$$

Tabulating and plotting h(tⱼ) from model Mⱼ yields the hazard curve. From this tabulation, S(tⱼ) and ƒ(tⱼ) can be calculated according to Equations (9) and (10), where S(t₋₁)=1 as defined before.

In the interval probability approach, the model-development engine 116 can use the estimated probability function ƒ(tⱼ) to compute the remaining functions of interest, including the survival function, S(tⱼ), and the hazard rate, h(tⱼ). In some aspects, the training data set for this approach includes the entire performance window. Unlike the previous two cases, an entity experiencing the event in the time bin bounded by tⱼ₋₁ and tⱼ, yields a response variable of “1”; otherwise, the response variable is “0”. A binary classification model (e.g., logistic regression) is trained to generate a scoreⱼ for the time bin specified by model Mⱼ. The value of scoreⱼ provided by the model is defined as described above (e.g., with respect to the credit score example). Examples of formulas for implementing this approach are provided in Equations (11)-(13).

$$f ( {t}_{j} ) = 1 - \frac{{score}_{j}}{1000} \qquad ( 11 )$$

$$S ( {t}_{j} ) = 1 - {\sum }_{k = 1}^{j} f ( {t}_{j} ) \qquad ( 12 )$$

$$h ( {t}_{j} ) = \frac{f ( {t}_{j} )}{S ( {t}_{j - 1} )} \qquad ( 13 )$$

Tabulating and plotting ƒ(tⱼ) from model Mⱼ yields the probability distribution curve. From this tabulation, S(tⱼ) and h(tⱼ) can then be calculated according to Equations (12) and (13), where S(t₋₁)=1 as defined before.

It is noted that the value of scoreⱼ as utilized in Equations (5), (8), and (11) is not the same value in each case because the definitions of the data sets and targets are different across the three cases.

Examples of model-estimation techniques that can be used in survival analysis modeling include a parametric approach, a non-parametric approach, and a semi-parametric approach. The parametric approach assumes a specific functional form for a hazard function and estimates parameter values that fit the hazard rate computed by the hazard function to the training data. Examples of probability density functions from which parametric hazard functions are derived are the exponential and Weibull functions. One parametric case can correspond to an exponential distribution, which depends on a single “scale” parameter 2 that represents a constant hazard rate across the time bins in a training window. A Weibull distribution can offer more flexibility. For example, a Weibull distribution provides an additional “shape” parameter to account for risks that monotonically increase or decrease over time. The Weibull distribution coincides with the exponential distribution if the “shape” parameter of the Weibull distribution has a value of one. Other examples of distributions uses for a parametric approach are the log-normal, log-logistic, and gamma distributions. In various aspects, the parameters for the model can be fit from the data using maximum likelihood.

The Cox Proportional Hazards (“CPH”) model is an example of a non-parametric model in survival analysis. This approach assumes that all cases have a hazard function of the same functional form. A predictive regression model provides scale factors for this “baseline” hazard function, hence the name “proportional hazards.” These scale factors translate into an exponential factor that transforms a “baseline survival” function into survival functions for the various predicted cases. The CPH model utilizes a special partial likelihood method to estimate the regression coefficients while leaving the hazard function unspecified. This method involves selecting a particular set of coefficients to be a “baseline case” for which the common hazard function can be estimated.

Semi-parametric methods subdivide the time axis into intervals and assume a constant hazard rate on each interval, leading to the Piecewise Exponential Hazards model. This model approximates the hazard function using a step-wise approximation. The intervals can be identically sized or can be optimized to provide the best fit with the fewest models. If the time variable is discrete, a logistic regression model can be used on each interval. In some aspects, the semi-parametric approach provides advantages over the parametric modelling technique and the CPH method. In one example, the semi-parametric approach can be more flexible because the semi-parametric approach does not require the assumption of a fixed parametric form across a given training window.

FIG. 3 depicts an example of a process 300 for training a set of multiple modeling algorithms and thereby estimating a time period in which a target event will occur. For illustrative purposes, the process 300 is described with reference to implementations described with respect to various examples depicted in FIG. 1. Other implementations, however, are possible. The operations in FIG. 3 are implemented in program code that is executed by one or more computing devices, such as the development computing system 114, the host computing system 102, or some combination thereof. In some aspects of the present disclosure, one or more operations shown in FIG. 3 may be omitted or performed in a different order. Similarly, additional operations not shown in FIG. 3 may be performed.

At block 302, the process 300 can involve accessing training data for a training window that includes data samples with values of predictor variables and a response variable. Each predictor variable can correspond to an action performed by an entity or an observation of the entity. The response variable can have a set of outcome values associated with the entity. The model-development engine 116 can implement block 302 by, for example, retrieving predictor data samples 122 and response data samples 126 from one or more non-transitory computer-readable media. In other aspects, the predictor variables and response variables include wavelet predictor variable data determined as described herein.

In some aspects, at block 304, the process 300 can involve partitioning the training data into training data subsets for respective time bins within the training window. For example, the model-development engine 116 can implement block 302 by creating a first training subset having predictor data samples 122 and response data samples 126 with time indices in a first time bin, a second training subset having predictor data samples 122 and response data samples 126 with time indices in a second time bin, etc. In other aspects, block 304 can be omitted.

In some aspects, the model-development engine 116 can identify a resolution of the training data and partition the training data based on the resolution. In one example, the model-development engine 116 can identify the resolution based on one or more user inputs, which are received from a computing device and specify the resolution (e.g., months, days, etc.). In another example, the model-development engine 116 can identify the resolution based on analyzing time stamps or other indices within the response data samples 126. The analysis can indicate the lowest-granularity time bin among the response data samples 126. For instance, the model-development engine 116 could determine that some data samples have time stamps identifying a particular month, without distinguishing between days, and other data samples have time stamps identifying a particular day from each month. In this example, the model-development engine 116 can use a “month” resolution for the portioning operation, with the data samples having a “day” resolution being grouped based on their month.

At block 306, the process 300 can involve building a set of timing-prediction models from the partitioned training data by training each timing-prediction model with the training data. In some aspects, the model-development engine 116 can implement block 306 by training each timing-prediction model (e.g., a neural network, logistic regression, tree-based model, or other suitable model) to predict the likelihood of an event (or the event's absence) during a particular time bin or other time period for the timing-prediction model. For instance, a first timing-prediction model can learn, based on the training data, to predict the likelihood of an event occurring (or the event's absence) during a three-month period, and a second timing-prediction model can learn, based on the training data, to predict the likelihood of the event occurring (or the event's absence) during a six-month period.

In additional or alternative aspects, the model-development engine 116 can implement block 306 by selecting a relevant training data subset and executing a training process based on the selected training data subset. For instance, if a hazard function approach is used, the model-development engine 116 can train a neural network, logistic regression, tree-based model, or other suitable model for a first time bin (e.g., 0-3 months) using a subset of the predictor data samples 122 and response data samples 126 having time indices within the first time bin. The model-development engine 116 trains the model to, for example, compute a probability of a response variable value (taken from response data samples 126) based on different sets of values of the predictor variable (taken from the predictor data samples 122).

In some aspects, block 306 involves computing survival functions for overlapping time bins. In additional or alternative aspects, block 306 involves computing hazard functions for non-overlapping time bins.

The model-development engine 116 iterates block 306 for multiple time periods. Iterating block 306 can create a set of timing-prediction models that span the entire training windows. In some aspects, each iteration uses the same set of training data (e.g., using an entire training dataset over a two-year period to predict an event's occurrence or non-occurrence within three months, within six months, within twelve months, and so on). In additional or alternative aspects, such as hazard function approaches, this iteration is performed for each training data subset generated in block 304.

At block 308, the process 300 can involve generating program code configured to (i) compute a set of probabilities for an adverse event by applying the set of timing-prediction models to predictor variable data and (ii) compute a time of the adverse event from the set of probabilities. For example, the model-development engine 116 can update the timing-prediction model code 130 to include various model parameters computed at block 306, to implement various model architectures computed at block 306, or some combination thereof.

In some aspects, computing a time of the adverse event (or other event of interest) at block 308 can involve computing a measure of central tendency with respect to a curve defined by the collection of different timing-prediction models across the set of time bins. For instance, the set of timing-prediction models can be used to compute a set of probabilities of an event's occurrence or non-occurrence over time (e.g., over different time bins). The set of probabilities over time defines a curve. For instance, the collective set of timing-prediction models results in a survival function, a hazard function, or an interval probability function. A measure of central tendency for this curve can be used to identify an estimate of a particular predicted time period for the event of interest (e.g., a single point estimate of expected time-to-default). Examples of measures of central tendency include the mean time-to-event (e.g., area under the survival curve), a median time-to-event corresponding to the time where the survival function equals 0.5, and a mode of the probability function of the curve (e.g., the time at which the maximum value of probability function ƒ occurs). A particular measure of central tendency can be selected based on the characteristics of the data being analyzed. At block 308, a time at which the measure of central tendency occurs can be used as the predicted time of the adverse event or other event of interest. In various aspects, such measures of central tendency can also be used in timing-prediction models involving a survival function, in timing-prediction models involving a hazard function, in timing-prediction models involving an interval probability function, etc.

In aspects involving a timing-prediction model using a survival function, which indicates an event's non-occurrence, the probability of the event's occurrence for a particular time period can be derived from the probability of non-occurrence (e.g. by subtracting the probability of non-occurrence from 1), where the measure of central tendency is used as the probability of non-occurrence. In aspects involving a timing-prediction model using a hazard function, which indicates an event's occurrence, the probability of the event's occurrence for a particular time period can be the measure of central tendency is used as the probability of non-occurrence.

At block 310, the process 300 can involve outputting the program code. For example, the model-development engine 116 can output the program code to a host computing system 102. Outputting the program code can include, for example, storing the program code in a non-transitory computer-readable medium accessible by the host computing system 102, transmitting the program code to the host computing system 102 via one or more data networks, or some combination thereof

Experimental Examples Involving Certain Aspects

An experimental example involving certain aspects utilized simulated data having 200,000 samples from a set of log-normal distributions. The set of log-normal distributions was generated from a single predictor variable with five discrete values, as computed by the following function:

log(Tᵢ)=βxᵢ+N(μ,σ) (14)

In Equation (14), β=log(4), μ=2, σ=0.25 and xᵢ∈{0.00, 0.25, 0.5, 0.75, 1.00}. The log-normal distribution can be used was used for two reasons: a normal distribution was chosen for the error term because this is typical in a linear regression model, and the logarithm was chosen as the link function to yield only positive values for a time period in which “survival” (i.e., non-occurrence of an event of interest) occurred. Discrete values of a single predictor were chosen to enhance visualization and interpretation of results.

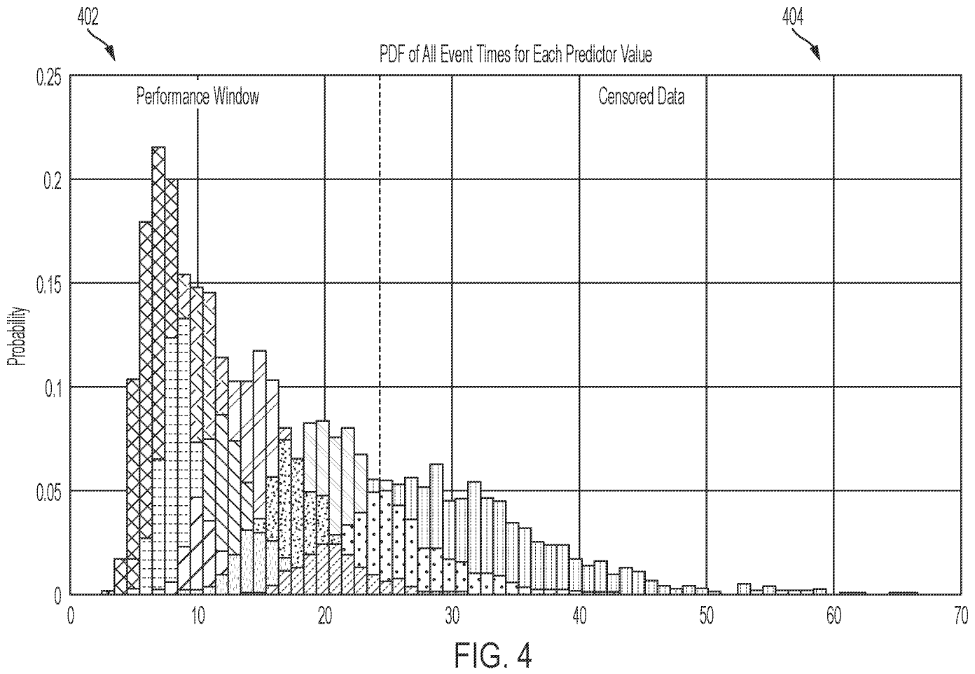

FIG. 4 illustrates simulated data distributions for each predictor value xᵢ used in Equation (14). In this example, probability density functions are depicted, with a performance window 402 of 24 months and a censored data 404 beyond the performance window 402.

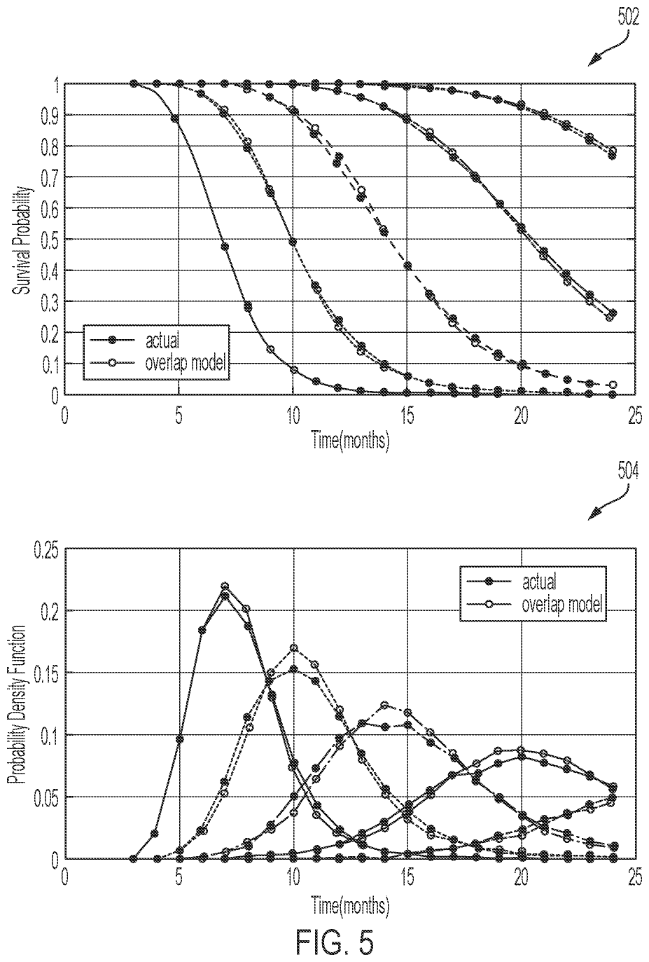

FIG. 5 demonstrates the performance of overlapping survival models on monthly time bins, with the time (in months) as the x-axis in each of graphs 502 and 504. In this example, logistic regression models were built for each month from 3 up to 25. These models yield the survival values for each month, which can be converted into corresponding hazard functions and probability density functions. Graph 502 compares actual and modeled survival functions, with the survival probability being the y-axis. Graph 504 compares actual probability functions with those computed from the modeled survival functions using Equation (6), with the probability density function being the y-axis.

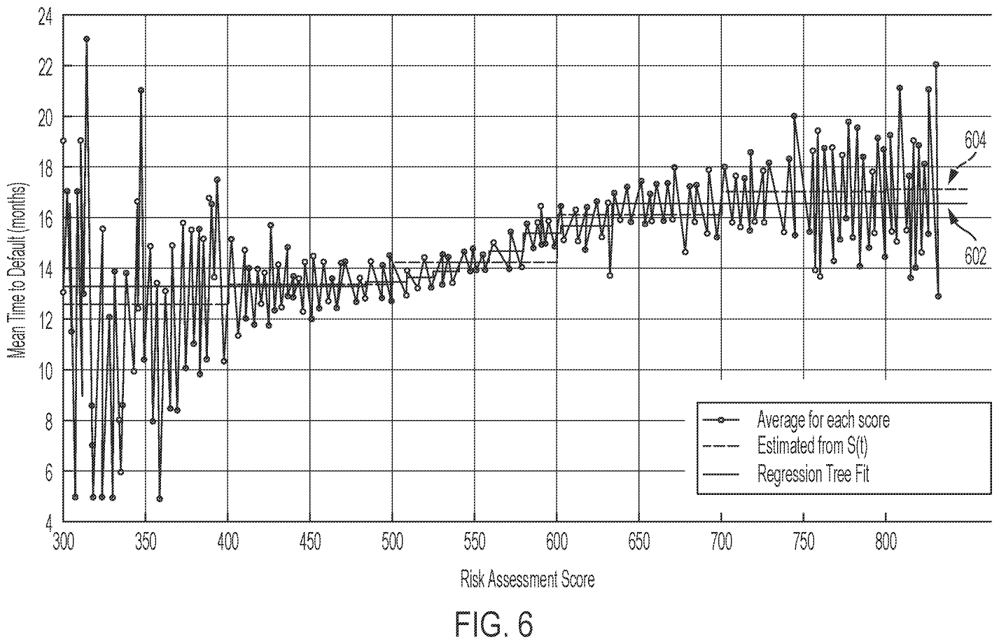

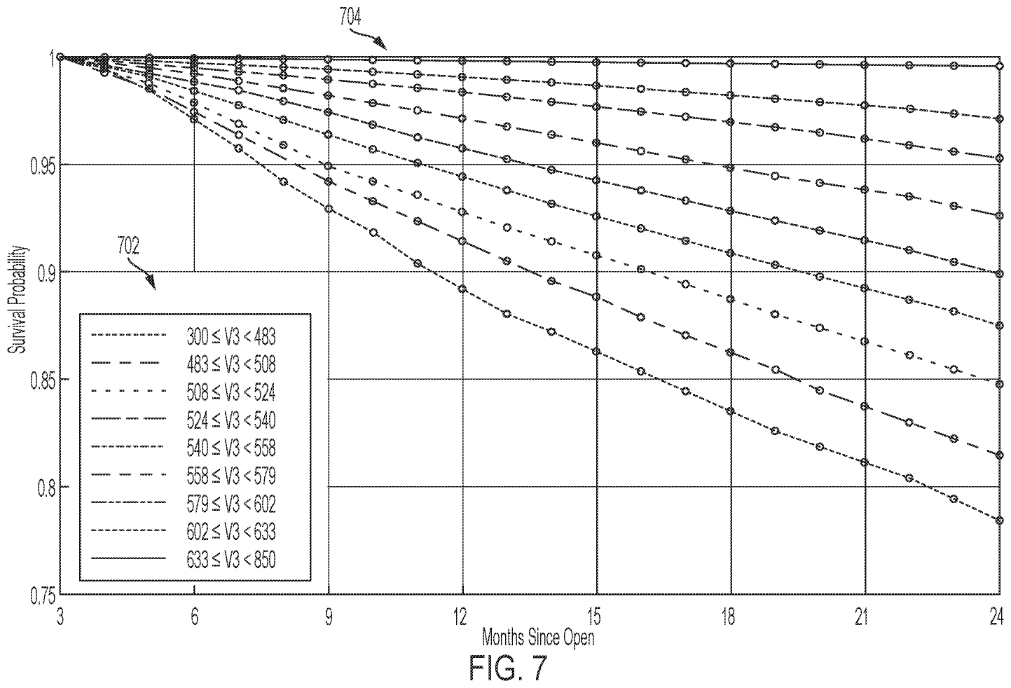

In some aspects, regression trees can be applied to exploratory data analysis and predictor variable binning for survival models. FIG. 6 is a graph for an illustrative example in which the target event is a default. FIG. 6 demonstrates the relationship between the model target variable, time to default, and a possible predictor variable, such as a risk assessment score (e.g., the Vantage 3.0 score), that is useful for the EDA step in a model building process. The results estimated from a survival function S(t) are depicted using a dashed line 604. The regression tree fit is depicted using the solid line 602. In this example, the depicted results show that a tree-based model can be used to effectively bin the predictor variables for credit risk timing models. FIG. 7 illustrates an example of Kaplan-Meier estimates of the survival function using ranges of a risk assessment score (e.g., a Vantage 3.0 score) that are constructed from a regression tree model. In this example, different ranges 702 of the risk assessment score result in distinct survival functions 704 for different classes of entities (e.g., entities with different levels of credit risk).

Examples of Using Wavelet Predictor Variable Data as Input to Timing-Prediction Models

In certain aspects, the development computing system 114 generates timing-prediction models that are configured for using wavelet predictor variable data as input. For instance, a set of timing-prediction model code 130 could include operations for computing a wavelet from raw time series data. Such a wavelet can be a weighted set of scaled and shifted basis functions that, in combination, represent the time series data. These operations include converting, using a wavelet transform, the raw time series data into input wavelet predictor variable data that includes a set of wavelet coefficients. The set of wavelet coefficients includes a set of shift values for each of a set of scales, each scale corresponding to a component basis function of the wavelet transform.

In certain examples, the timing-prediction model code 130, when executed by a computing system (e.g., a host computing system 102 or a development computing system 114), applies a machine-learning model to the set of wavelet coefficients to determine a probability of a target event. In other examples, the timing-prediction model code 130, when executed by a computing system (e.g., a host computing system 102 or a development computing system 114), applies a machine-learning model to each set of shift values of the set of wavelet coefficients to determine a respective scale-specific probability. The machine-learning model also computes a probability of a target event as a function (e.g., an average) of the determined scale-specific probabilities. The trained model in these examples can be a tree-based model.

In additional or alternative aspects, the machine-learning model can be a linear regression model or a neural network model. In these aspects, the machine-learning model can preprocess the set of wavelet coefficients to determine, from the sets of shift values of the wavelet coefficients, a single set of values. The machine-learning model, when applied to the single set of values, can compute the probability of the target event.

In an example, a computing system that executes the timing-prediction model code 130 receives time-series data for an entity. For instance, the predictor data samples 122 include the raw time series data. In certain examples, the time series data is derived from panel data that includes archives that describe attributes of one or more accounts of one or more entities over a time period. Panel data can include transaction information, balance information, or other information that is retrieved from raw tradeline data. In certain examples, the computing system receives raw tradeline data from one or more financial institutions and generates the panel data from the raw tradeline data. The computing system determines or otherwise receives time-series data for each attribute for each entity. Time-series attributes are created by stacking several archives together to create stacked panel data (e.g. longitudinal data or repeated measures).

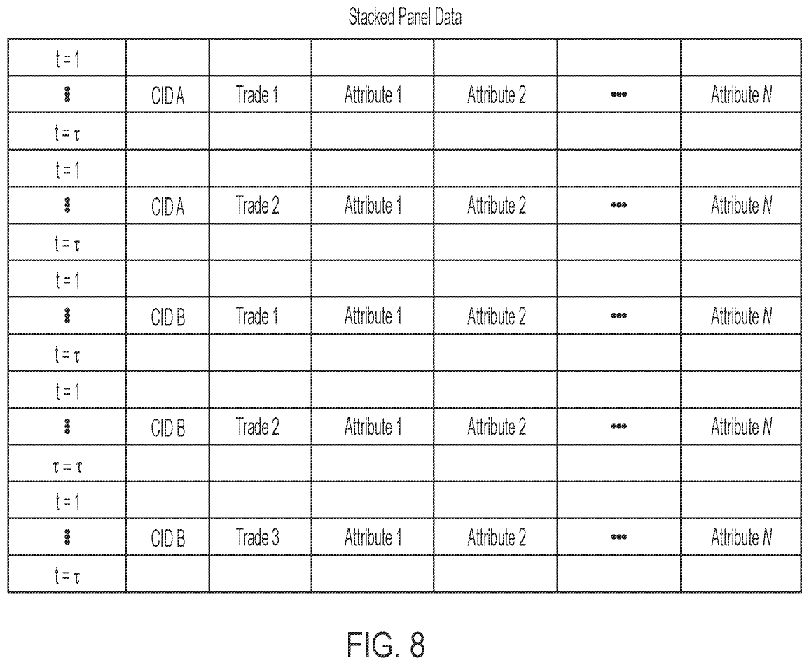

FIG. 8 illustrates an example of a table of a portion of stacked panel data constructed from multiple archives for every account for a set of entities. As illustrated in FIG. 8, the archives (represented by rows) are stacked according to customer identifiers, which identify an entity. For instance, customer identifier A (“CID A”) corresponds to the top two archives and customer identifier B (“CID B”) corresponds to the three archives below CID A. Each customer identifier is associated with a respective entity. Each archive includes a row representing a set of N attributes {1, 2, . . . . N} that corresponds with a particular trade (e.g. Trade 1, Trade 2, Trade 3, etc.). (It is noted that any use of the variables k, K, j, J, n, or N in discussion herein with respect to FIGS. 8-24 is different from any use of the variables k, K, j, J, n, or N in FIGS. 1-7.) A trade represents a specific account of a particular entity associated with the particular customer identifier in the archive. Attributes can include an account balance, a number of days that a balance is past due, a number of days until a balance is due, a number of late payments, or value representing a quantitative or qualitative attribute of an account. As illustrated in FIG. 8, the exemplary panel data describes attributes of accounts of entities for a first time interval (“t=1”) of a particular time period (“t=T”).

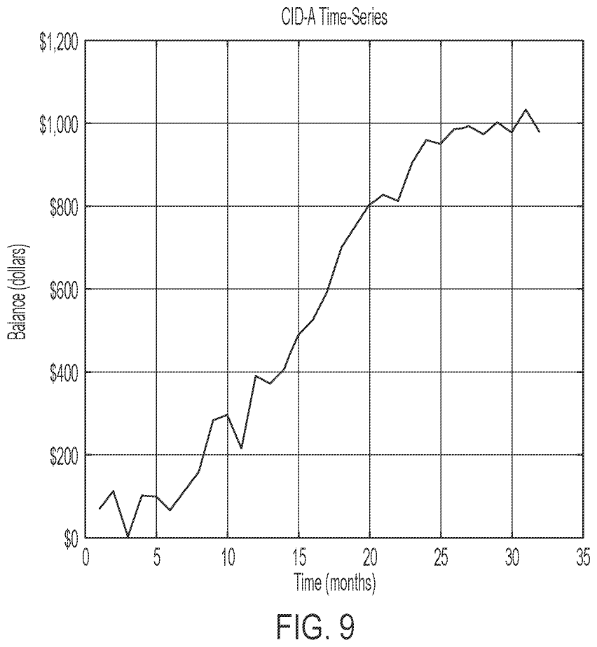

FIG. 9 illustrates a single attribute, “account balance,” derived from panel data such as the panel data illustrated in FIG. 8, as time-series data. FIG. 9 depicts time-series data indicates values of an attribute over a time period for customer identifier A (CID A) of FIG. 1(a) derived from multiple archives of panel data of FIG. 8.

Continuing with this example, the computing system that executes the timing-prediction model code 130 generates a wavelet transform to represent the time-series data for the entity. For instance, a wavelet transform is a weighted set of scaled and shifted basis functions that, combined, represent the time series data. In certain examples, the computing system generates the wavelet transform using Haar wavelet basis functions. However, other wavelet basis functions can be used. In certain examples, the wavelet transform is represented as a matrix and the wavelet transform is implemented by convolution comprising a time-reversal of wavelets stored as rows in a wavelet-transform matrix followed by matrix-matrix multiplication. In certain examples, the wavelet transform is not shift invariant and shifting the time-series by one or more periods in either direction will yield different results, in that a change in a shift value could result in substantially different coefficients that scale the basis functions. For example, to make the wavelet transform shift invariant, the computing system adds redundant rows to the wavelet-transform matrix by shifting the existing basis functions to cover all possible shifts in a time period to generate a Redundant Discrete Wavelet Transform or a Maximum Overlap Discrete Wavelet Transform. Adding the redundant rows can allow any subset of a set of time series data to be reconstructed from the set of scaled and shifted functions used to represent the set of time series data Adding the redundant rows can also create a linear dependence among at least some of the scaled and shifted functions used to represent the time series data. However, in this example, the set of wavelets is no longer a basis, since this linear dependence among basis functions means that one or more the scaled and shifted functions can be obtained as a weighted sum of other functions used to represent the time series data.

To generate the wavelet transform, the computing system decomposes the time-series into a weighted set of stereotypical basis functions from which the original time-series can be recovered. The wavelet transform provides the capability to localize events in time as well as measure their composition in terms of scale or frequency of an underlying stereotypical function.

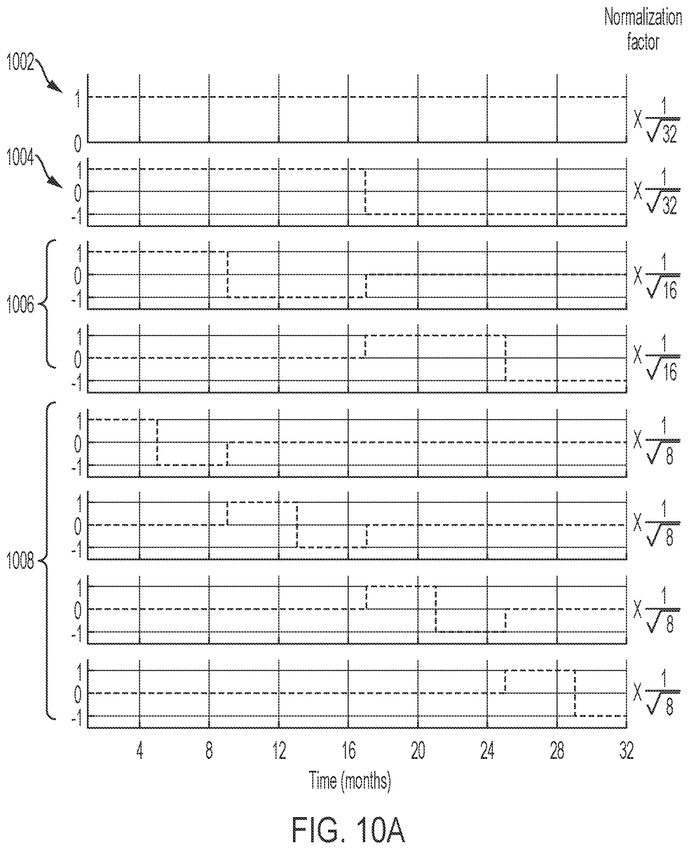

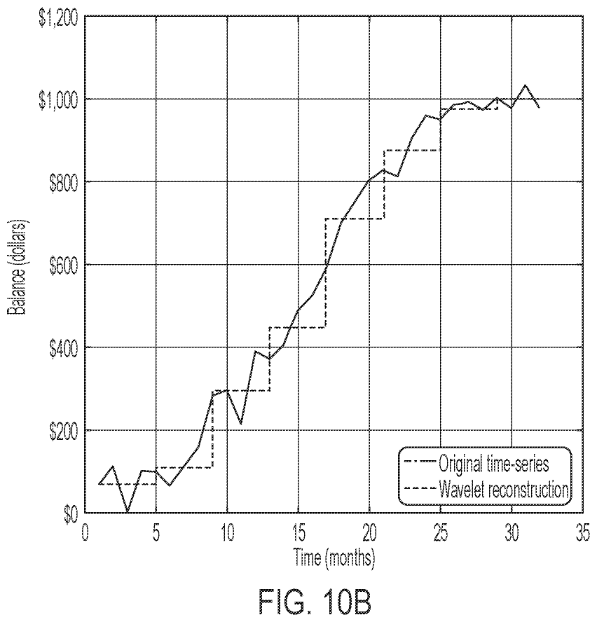

FIGS. 10(a) and 10(b) illustrate a Haar wavelet approximation to the time-series of FIG. 9 capturing an entity's account balance over the last 32 months. The entity could include a consumer, an organization, a computing system, a computing device, or other entity. FIG. 10(a) illustrates a select subset of Haar wavelets at various scales and shifts. The selected subset illustrated in FIG. 10(a) is orthogonal such that an inner product of any wavelet in the set with any other yields a value of “0” and scale factors ensure that the inner product of a wavelet with itself yields a value of “1”, making the set orthonormal. These two qualities (orthogonality and orthonormality) make this set a basis. FIG. 10(b) shows the account balance time-series of FIG. 9 with an approximation constructed from the basis subset of Haar wavelets shown in FIG. 10(a).

In certain examples, the computing system can increase an accuracy of an approximation of a time series by adding more wavelets to the set of basis functions at more refined time scales. For example, the number of scales is one, two, ten, twenty, or other specified number. Increasing the number of scales may result in a greater accuracy of prediction by better capturing trends within time intervals but a lower processing speed due to increased complexity of a calculation involved in determining an output while decreasing the number of scales may result in a lesser accuracy of prediction but a greater processing speed.

In certain examples, the computing system computes weights required by the basis set to reconstruct the original time-series by pre-multiplying an attributes matrix having columns representing original attributes (of the set of N attributes) from each archive in the stacked panel data and having rows representing the stacked panel data by the wavelet-transform matrix. The wavelet transform matrix has rows representing each wavelet basis function in the set and has columns corresponding to the same time samples indexed by archives in the attributes matrix.

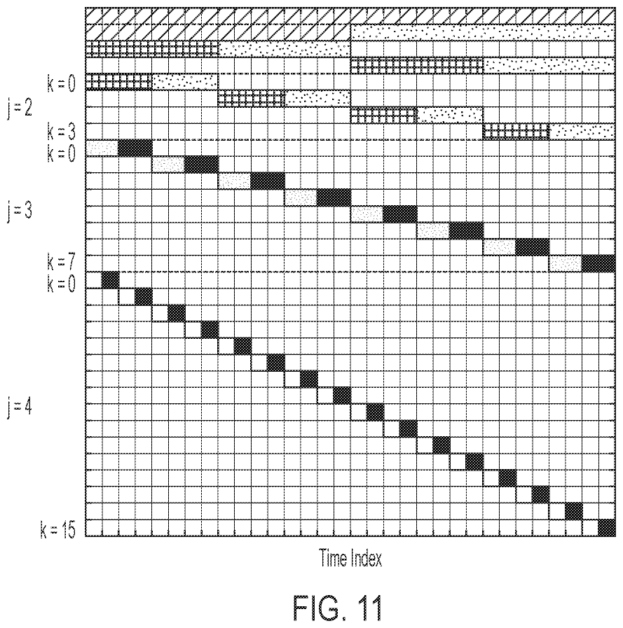

FIG. 11 illustrates an example of a wavelet basis set matrix comprised of Haar wavelets from FIGS. 10(a) and 10(b). As illustrated in FIG. 11, each row in this illustration of a wavelet transform matrix is a distinct wavelet corresponding to different scale and shift parameters. In FIG. 11, the variable t is time, the variable j is scale, the variable k is shift. In FIG. 11, diagonal lines, crosses, and no shading (white) with a heavy border represent positive values (where crosses indicate a greater positive value than diagonal lines and no shading with a border indicates a greater positive value than crosses). In FIG. 11, light dots, heavy dots, and fully shaded (black) represent negative values (where fully shaded indicates a negative value of greater magnitude than heavy dots and heavy dots indicates a negative value of greater magnitude than light dots). In FIG. 11, no shading (i.e., white) without a heavy border represent zero values. For instance, the first and second row vectors of the wavelet transform matrix in FIG. 11 (i.e., scale of j=0) corresponds to the wavelets 1002 and 1004, respectively, from FIG. 10(a). The first row, like wavelet 1002, includes positive values of the wavelet for all values of t, and the second row, like wavelet 1004, includes positive values of the wavelet for a first set of values of t followed by negative values of the wavelet for a subsequent set of values of t. The following two row vectors of this wavelet transform matrix in FIG. 11 (i.e., scale of j=1 with two associated shift values) correspond to the set of wavelets 1006 from FIG. 10(a). The following group of four row vectors of this wavelet transform matrix (i.e., the four row vectors for j=2) correspond to the set of wavelets 1008 in FIG. 10(a). Additional groups of row vectors in the wavelet transform matrix correspond to additional scale values (e.g., j=3 with eight associated shift values and j=4 with sixteen associated shift values).

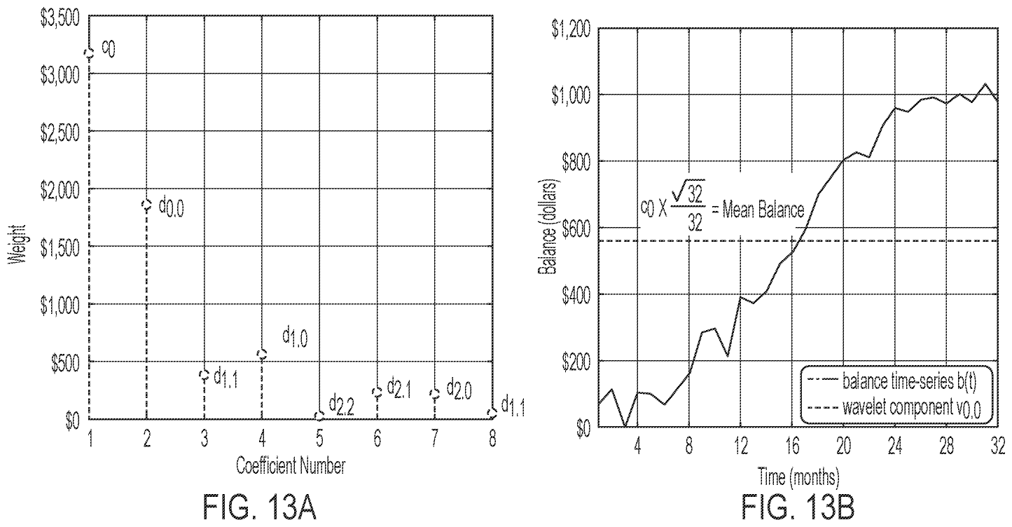

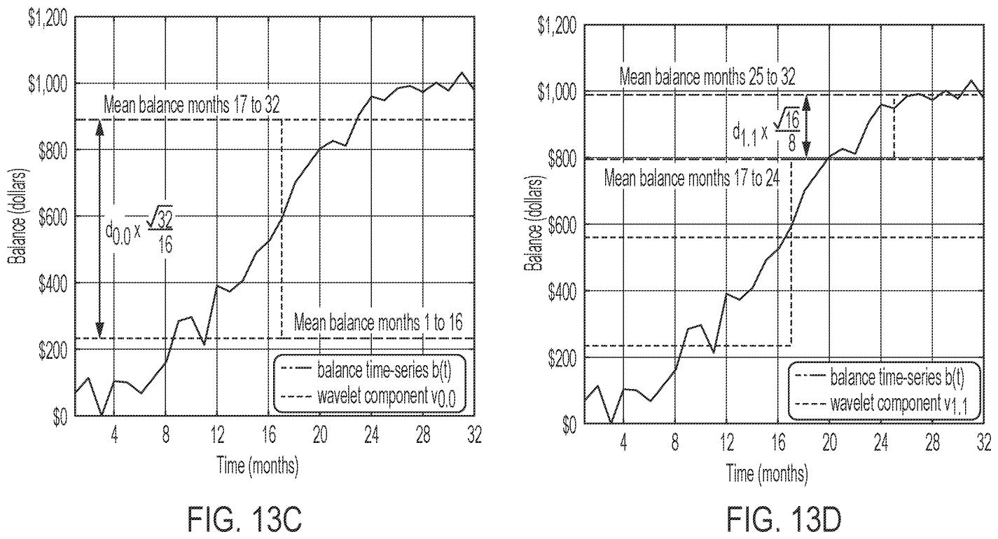

The first row of the wavelet transform matrix (i.e., the shift k=0 for the scale j=0) depicted in FIG. 11 represents a sum of all time-series samples. The remaining rows of the wavelet transform matrix depicted in FIG. 11 include differences of sums of the time series over various scales and at various non-overlapping shifts (at the same scale). The differences at finer scales completely fall within the sum/differences of the prior scale. At each scale and shift, the time-series values corresponding to white (no shading) with no heavy border are zeroed out and contribute nothing, the white (no shading) with heavy border sums up the corresponding values, and the fully shaded (black) subtracts the corresponding values. This can be seen as subtracting the average of samples over one time-window from the average of samples over the previous time-window. Further examples of this concept are depicted in FIGS. 13B-13D.

Continuing with this example, the computing system converts the time series data into a set of wavelet predictor variable data using the wavelet transform and the time series data. The computing system determines a wavelet basis set matrix (as illustrated in FIG. 11) having rows corresponding to individual wavelet basis functions which are scaled and shifted copies of the specified basis functions and columns corresponding to a time index of the time series data to be transformed. The computing system flips the wavelet basis set matrix from left to right to implement a time reversal that mimics convolution. The computing system retrieves the stacked panel data and converts the time series data into a set of wavelet predictor variable data by multiplying the stacked panel data and the flipped wavelet basis set matrix. As previously discussed, the stacked panel data (illustrated in FIG. 8) includes panels correspond to consumers, accounts, etc. and each panel is organized into rows corresponding to time samples of measured data and columns corresponding to measured attribute data.

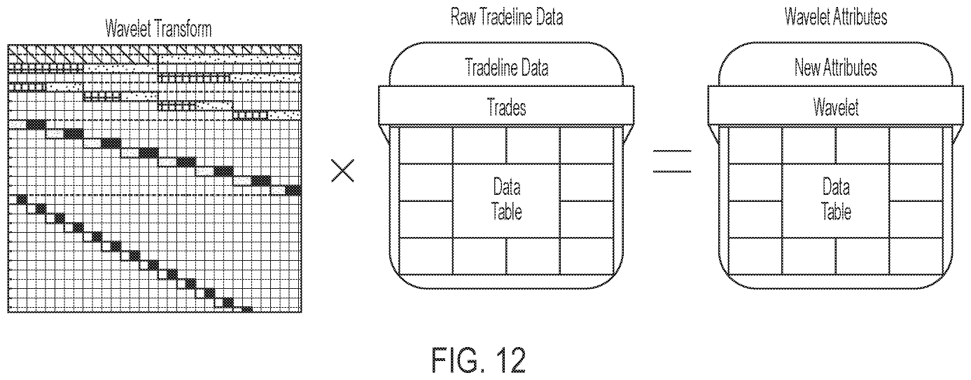

In certain examples, the computing system can generate a wavelet predictor variable data table that includes panel data analogous to the input stacked panel data table. In the wavelet predictor variable data table, however, rows in each panel correspond to shifts in the specified basis functions and columns correspond to each transformed measurement at every scale of the specified basis functions. In the example depicted in FIG. 12, the computing system generates a wavelet predictor variable data table (i.e., the data table labeled “Wavelet Attributes”) by multiplying stacked panel data (i.e., the data table labeled “Raw Tradeline Data”) by a flipped wavelet basis set matrix.

As illustrated in FIG. 12, conversion from stacked panel data (e.g. a raw-tradeline data table) to a wavelet predictor variable data table results from multiplying the stacked panel data having time-indexed columns by the flipped wavelet-transform matrix, which represents a convolution of each wavelet function (row). Convolution comprises horizontally flipping the wavelet-transform matrix to “time-reverse” the wavelets, followed by matrix-matrix multiplication with a matrix representing the stacked panel data for a single account or account type within the stacked panel data table.

The wavelet predictor variable data table, which results from the application of the wavelet transform to a time series, can include a set of coefficients corresponding to each basis function in the set. FIGS. 13(a), 13(b), 13(c), and 13(d) illustrate examples of coefficients of a wavelet predictor variable data table determined in FIG. 12 through multiplying the stacked panel data table of FIG. 8 by an inversion of the wavelet matrix of FIG. 11.

FIG. 13(a) illustrates wavelet coefficients for given subset of wavelet functions. FIG. 13(b) illustrates a first wavelet coefficient for an average balance over entire 32-month window. FIG. 13(c) illustrates a second wavelet coefficient for a scaled version of difference of average balance over the last 16 months and previous 16 months. The second coefficient is directly proportional to the difference between the average balances of the last 16 months and the 16 months prior to that, and thus gives an indication of how much the balance is changing over the 32 month period FIG. 13(d) illustrates a third wavelet coefficient for a scaled version of a difference of an average balance over last 8 months and previous 8 months. The third coefficient is directly proportional to the difference between average balances of the last 8 months and the 8 months prior to that in the last 16 month period. Taken together, the three coefficients show how much an account balance has changed over different time-scales, and where those changes have occurred in time.

In some aspects, the development computing system 114 can generate the timing-prediction model code by building a set of nested-interval category prediction models (e.g. logistic regression, multinomial regression, etc.) using predictor variable data from the wavelet predictor variable data table. For instance, nested intervals may define the targets for each of the models in a set of models. In one example, a first model predicts an event in an interval from a beginning of the performance window (t=0) to 6 months later (t=6), a second model predicts the event in an interval from t=0 to t=12 covering the first 12 months of the performance window, and a third model predicts the event in an interval between t=0 to t=18 covering the first 18 months of the performance window, etc. The interval definitions of this example are provided for example only, and the development computing system 114 can build the set of nested-interval models using other intervals. Further, various other models could be used instead of (or in addition to) logistic regression or multinomial regression models, such as a set of classification and regression tree (CART) models, a set of neural network (NN) models, a set of time-delay neural network (TDNN) models, a set of Convolutional Neural Network (CNN) models, a set of Recurrent Neural Network (RNN) models, or a set of any other type of classifier.

Continuing with this example, a computing system that executes the timing-prediction model code 130 can input the set of shift values for each scale of the wavelet predictor variable data table to the trained multiple modeling algorithms to generate a probability for an event occurring in the time window associated with the timing-prediction model. For instance, the computing system applies the set of timing prediction models to the shift values corresponding to the scales of the wavelet predictor variable data table to determine a set of probabilities corresponding to the number of timing-prediction models. In other examples, a computing system that executes the timing-prediction model code 130 inputs, for each scale of the wavelet predictor variable data table, a set of shift values to the trained multiple modeling algorithms to generate scale-specific probabilities. For instance, the computing system applies the set of timing prediction models to each set of shift values (corresponding to each scale) of the wavelet predictor variable data table to determine a set of scale-specific probabilities corresponding to the number of scales in the wavelet predictor variable data table. The computing system can determine combined probabilities from the scale-specific probabilities. In one example, the computing system may determine a set of combined probabilities as a function of the set of scale-specific probabilities for the set of timing prediction models. For instance, an average, a weighted average, a median, or other function is applied to a particular set of scale-specific probabilities for a particular timing prediction model (of the set of timing prediction models) to determine a particular combined probability.

The aspects described herein can be adapted to tree-based timing prediction models. However, in other aspects, the computing system utilizes linear regression models or neural network models. In certain aspects, a computing system that executes the timing-prediction model code 130 preprocesses the set of wavelet coefficients to determine, from the sets of shift values of the wavelet coefficients, a single set of predictor variables 124. The computing system applies a trained machine-learning model, which is generated using the process 300, to the single set of predictor variables 124 to determine the probability of the target event.

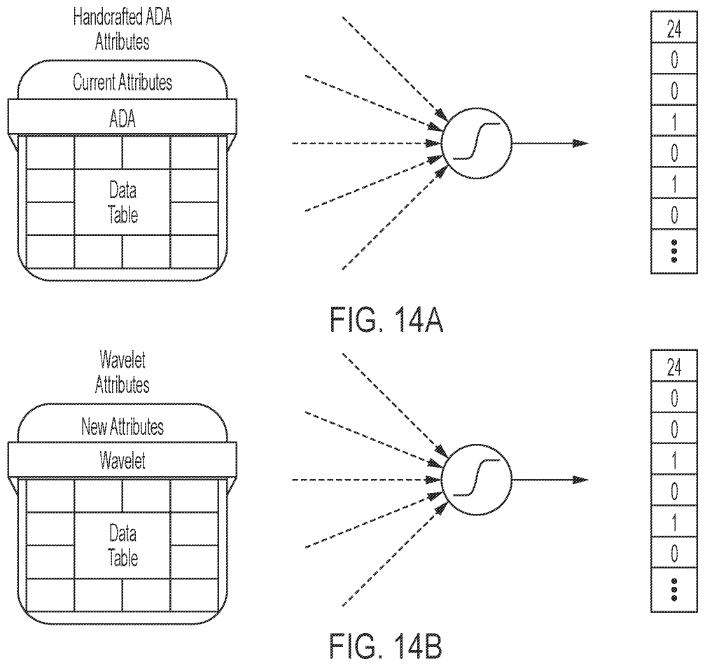

FIG. 14 illustrates a standard logistic regression model built using a table of attributes that are derived from stacked panel data. FIG. 14 illustrates a standard logistic regression model built using a wavelet predictor variable data table generated as in FIG. 12. FIG. 14 illustrates that the process of building a timing-prediction model using a wavelet predictor variable data table (as illustrated in item (b)) can proceed similarly to building a timing-prediction model using a standard attributes table (as shown in item (a)).

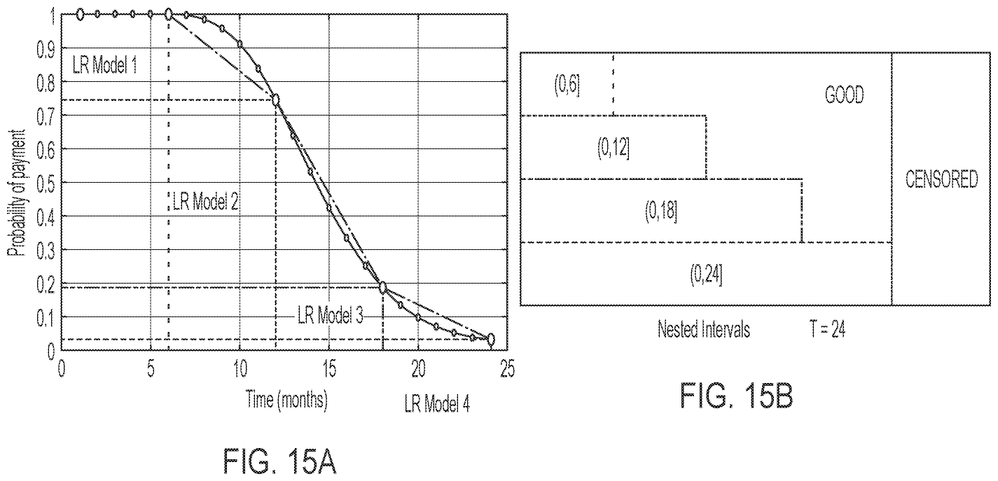

Nested-interval survival models predict a time-to-event as a simple extension to multiple overlapping performance windows as illustrated in FIGS. 15(a) and 15(b). Specifically, FIG. 15(a) illustrates an example of a survival function approximation using four binary logistic regression models where the model prediction target is defined as “1” if it falls within a corresponding time interval and “0” if it does not. FIG. 15(b) illustrates nested intervals on the same underlying data of FIG. 15(a) corresponding to different definitions of “bad” depending on the time interval for a given model.

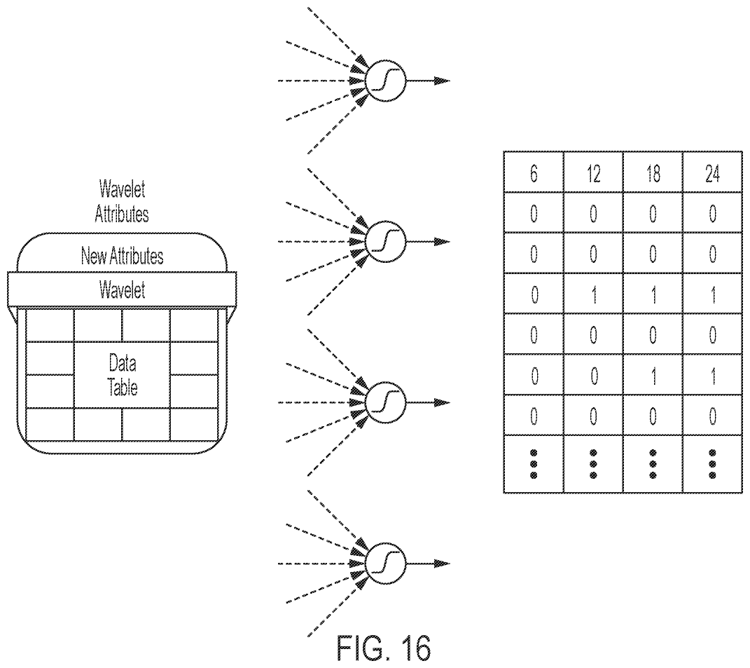

FIG. 16 illustrates applying inputs derived from the wavelet predictor variable data table of FIG. 12 to the nested-interval survival analysis model of FIG. 15(a). In this illustrative example, the inputs derived from the wavelet predictor variable data table of FIG. 12 are used to build a set of multiple credit risk models, where the target for each model changes depending on whether that specific account has gone “bad” within the time window specified by the column heading. While this example involves binary risk models predicting “good” or “bad” accounts, however, other types of categorical models describing occurrence of multiple events in overlapping time periods can be used in a wide variety of applications.

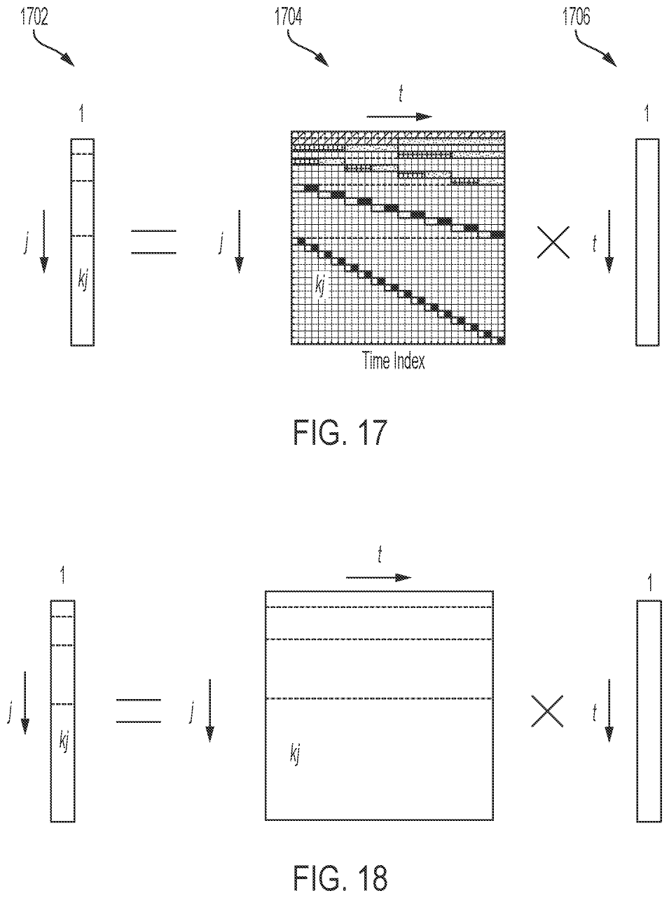

FIGS. 17 and 18 depict, for illustrative purposes, a simplified example of generating wavelet predictor variable data. In this simplified example, a zero-overlap wavelet transform for a single entity and a single attribute is used, where t is time, j is scale, and k is shift. The example in FIG. 17 depicts a vector 1702 of wavelet predictor variable data, which is generated by a matrix-vector multiplication of the Haar wavelet transform matrix 1704 (also depicted in FIG. 11) with a single original time-series attribute 1706. FIG. 18 depicts a simplified example of a generic zero-overlap wavelet transform. In the example depicted in FIG. 18, each scale j includes a group of kⱼ=2^{j} row vectors corresponding to non-overlapping shifts of the wavelet at scale j. Vector-matrix multiplication results in a column vector of wavelet coefficients having length Σⱼkⱼ.

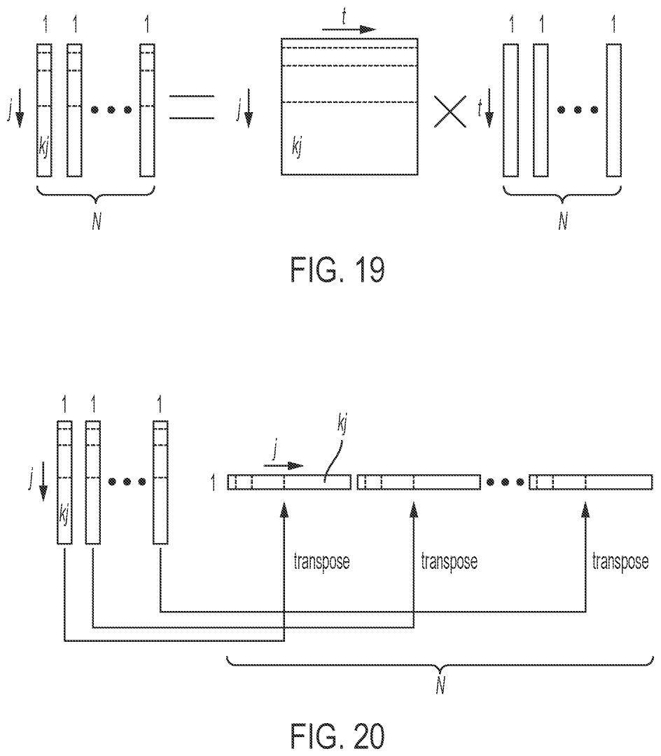

As noted above, a set of wavelet predictor variable data can be prepared for input into a survival model by identifying, for each entity, a respective set of rows corresponding to separate shifts in the panel and concatenating the identified set of rows into a single row. FIGS. 19 and 20 depict an illustrative example of this process. FIGS. 19 and 20 depict an illustrative example involving a zero-overlap wavelet transform for a single entity with multiple attributes. For instance, FIG. 19 depicts an example in which multiple attributes are handled by creating a matrix where each column represents an individual attribute. The operation now becomes a matrix-matrix multiplication. The columns of the output matrix represent the wavelet transform for each attribute. FIG. 20 depicts an example in which a single row of wavelet-transformed attributes for each entity can be created by peeling off each column in the resulting matrix, transposing each column into a row vector, and then concatenating each row to generate a concatenated row vector. The concatenated row vector can be inputted into a survival model as described herein. Such a survival model can be any architecture configured to receive a vector of values as an input (e.g., a neural network model, a logistic regression model, etc.).

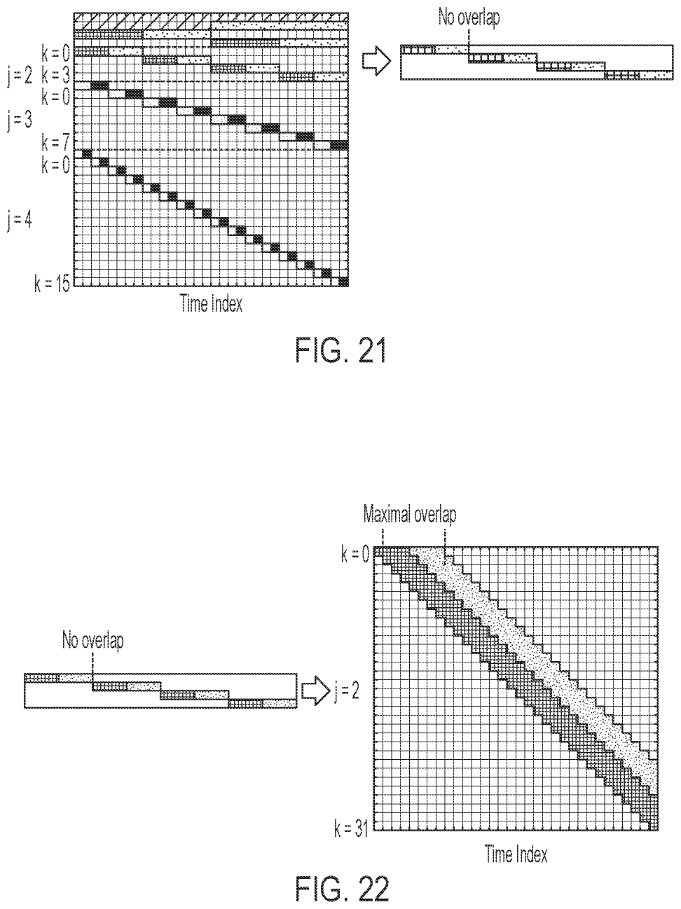

As noted above, some aspects involving making the wavelet transform shift invariant by adding redundant rows to the wavelet-transform matrix, thereby generating a Redundant Discrete Wavelet Transform or a Maximum Overlap Discrete Wavelet Transform (MODWT). FIGS. 21 and 22 depict an example illustrating a difference between a zero-overlap wavelet transform and the MODWT. FIG. 21 depicts the wavelet transform matrix from FIG. 11. In the example depicted in FIG. 21, all of the rows in the matrix on the left are orthogonal and hence linearly independent and thus form a basis.

To construct the MODWT, the computing system takes rows corresponding to each scale and creates new rows by shifting the first row of each scale one time-step to the right. This is maximal overlap because each row differs by only one time-step in the beginning and end. Submatrices of equal numbers of shifts are produced for each scale j. For instance, FIG. 22 depicts an example of a submatrix having 32 shift values that is generated for scale value j=2. The submatrix is computed by identifying the row vectors corresponding to j=2 in FIG. 21 and creating new rows by shifting the first of these identified row vectors for scale j=3 one time-step to the right.

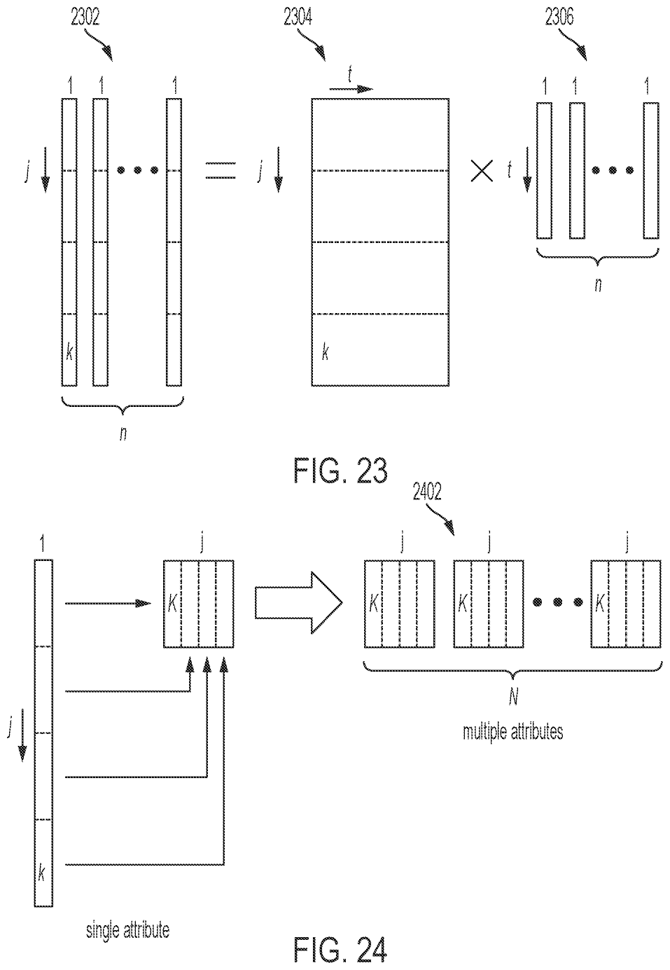

FIGS. 23 and 24 depict examples of options for reshaping the resultant matrix in the MODWT due to the fact that the number of shifts for each scale is the same. In FIG. 23, computation of the wavelet coefficients for multiple attributes is performed in the same manner as the non-redundant (basic wavelet) case depicted above. The example in FIG. 23 depicts a matrix 2302 of wavelet predictor variable data. The matrix 2302 includes n columns, each of which can be a vector of wavelet predictor variable data for a respective attribute. The matrix 2302 is generated by a wavelet transform matrix 2304 with a set of time-series attributes 2306 1 . . . N (i.e., a first time series for a first attribute, a second time series for a second attribute, and so on up to time series N for the attribute N).

In some aspects, a single row of wavelet-transformed attributes for the entity can be created from the matrix 2302. For instance, a computing system can identify the columns in the matrix 2302, transpose each of these column into a respective row vector, and then concatenating this set of row vectors to generate a concatenated row vector. The concatenated row vector can be inputted into a survival model as described herein. Such a survival model can be any architecture configured to receive a vector of values as an input (e.g., a neural network model, a logistic regression model, etc.).

In FIG. 24, a panel 2402 of wavelet-transformed attributes for the entity can be created from the matrix 2302. To generate this panel 2404, a computing system identifies each column in the matrix 2302 and splits the column, based on scale, into a set of multiple, equal length columns. For instance, in FIG. 24, a column from matrix 2302 that represents attribute 1 is split into a set of J columns, each of which has length K. The set of equal length columns for attribute 1 can be reshaped into a matrix 1 with K rows corresponding to shifts and J columns corresponding to scale. This process is repeated for each of the N columns of matrix 2302 that respectively correspond to N attributes, thereby generating a set of N matrixes. This set of N matrices can be concatenated to generate a panel 2402 for a given entity, where the panel 2402 has K rows and J×N columns.

This panel 2402 can be inputted into a survival model described herein. In some aspects, such a survival model M is implemented using a CART model. The CART model is applied to the panel 2402. The output of applying the CART model to the panel 2402 is a vector yₚₐₙₑₗ=[y_{panel,1} [symbol] y_{panel,K}]′ where each of the elements {y_{panel,1} . . . y_{panel,K}} has a value of 0 or a 1. The computing system generates an aggregated output Pₚₐₙₑₗ from this set of 0 and/or 1 values. The aggregated output can be computed as:

$${P}_{panel} = \frac{1}{K} {\sum }_{k = 0}^{K - 1} {y}_{panel , k}$$

In this example, Pₚₐₙₑₗ is the probability of the target event occurring.

Using the inputs described herein with respect to FIGS. 9-24 can provide improvements over conventional machine learning models. For instance, the conventional models make predictions using representative attributes for each of multiple time intervals determined from time series data (e.g. a first attribute value for a first monthly period, a second attribute value for a second monthly period, etc.) However, models that utilize the aspect described above with respect to FIGS. 9-24 can capture, more effectively than conventional machine learning models that use such representative attributes, trends within intervals of the time series data and thereby increase an accuracy of predictions generated by the models.

Examples of Host System Operations Using a Set of Timing-Prediction Models

A host computing system 102 can execute the timing-prediction model code 130 to perform one or more operations. In an illustrative example of a process executed by a host computing system 102, the host computing system 102 can receive or otherwise access predictor variable data. For instance, a host computing system 102 can be communicatively coupled to one or more non-transitory computer-readable media, either locally or via a data network. The host computing system 102 can request, retrieve, or otherwise access time series data (or other types of data depending on the type of prediction model) with respect to a target, such as a target individual or other entity. The host computing system 102 determines a wavelet transform to represent the time series data and generate a set of wavelet predictor variable data using the wavelet transform and the time series data. The wavelet predictor variable data includes a set of shift values for each of a set of scales. The wavelet predictor variable data can be represented by a matrix having rows representing scales and columns representing shifts, where each row of values in the matrix represents a set of shift values corresponding to a particular scale.

Continuing with this example, the host computing system 102 can compute a set of probabilities (or other types of risk indicator) for the target event by executing the predictive response application 104, which can include program code outputted by a development computing system 114. Executing the program code can cause one or more processing devices of the host computing system 102 to apply the set of timing-prediction models, which have been trained with the development computing system 114, to the wavelet predictor variable data. For instance, the host computing system 102 applies the set of timing prediction models to the shift values corresponding to different scales to determine a set of probabilities for the set of timing prediction models. The host computing system 102 can also compute, from the set of probabilities, a time of a target event (e.g., an adverse action or other events of interest). In another example, the host computing system 102 applies the set of timing prediction models to each set of shift values (corresponding to each scale) to determine a set of scale-specific probabilities corresponding to the number of scales in the wavelet predictor variable data. The host computing system 102 determines a set of combined probabilities as a function of the set of scale-specific probabilities for the set of timing prediction models. For instance, an average, a weighted average, a median, or other function is applied to a particular set of scale-specific probabilities for a particular timing prediction model (of the set of timing prediction models) to determine a particular combined probability (of the set of combined probabilities). The host computing system 102 can also compute, from the set of combined probabilities, a time of a target event (e.g., an adverse action or other events of interest).

The host computing system 102 can modify a host system operation based on the computed time of the target event. For instance, the time of a target event can be used to modify the operation of different types of machine-implemented systems within a given operating environment.

In some aspects, a target event includes or otherwise indicates a risk of failure of a hardware component within a set of machinery or a malfunction associated with the hardware component. A host computing system 102 can compute an estimated time until the failure or malfunction occurs. The host computing system 102 can output a recommendation to a consumer computing system 106, such as a laptop or mobile device used to monitor a manufacturing or medical system, a diagnostic computing device included in an industrial setting, etc. The recommendation can include the estimated time until the malfunction or failure of the hardware component, a recommendation to replace the hardware component, or some combination thereof. The operating environment can be modified by performing maintenance, repairs, or replacement with respect to the affected hardware component.

In additional or alternative aspects, a target event indicates a risk level associated with a target entity that is described by or otherwise associated with the predictor variable data. Modifying the host system operation based on the computed time of the target can include causing the host computing system 102 or another computing system to control access to one or more interactive computing environments by a target entity associated with the predictor variable data.

For example, the host computing system 102, or another computing system that is communicatively coupled to the host computing system 102, can include one or more processing devices that execute instructions providing an interactive computing environment accessible to consumer computing systems 106. Examples of the interactive computing environment include a mobile application specific to a particular host computing system 102, a web-based application accessible via mobile device, etc. In some aspects, the executable instructions for the interactive computing environment can include instructions that provide one or more graphical interfaces. The graphical interfaces are used by a consumer computing system 106 to access various functions of the interactive computing environment. For instance, the interactive computing environment may transmit data to and receive data from a consumer computing system 106 to shift between different states of interactive computing environment, where the different states allow one or more electronics transactions between the consumer computing system 106 and the host computing system 102 (or other computing system) to be performed. If a risk level is sufficiently low (e.g., is less than a user-specified threshold), the host computing system 102 (or other computing system) can provide a consumer computing system 106 associated with the target entity with access to a permitted function of the interactive computing environment. If a risk level is too high (e.g., exceeds a user-specified threshold), the host computing system 102 (or other computing system) can prevent a consumer computing system 106 associated with the target entity from accessing a restricted function of the interactive computing environment.

The following discussion involves, for illustrative purposes, a simplified example of an interactive computing environment implemented through a host computing system 102 to provide access to various online functions. In this example, a user of a consumer computing system 106 can engage in an electronic transaction with a host computing system 102 via an interactive computing environment. An electronic transaction between the consumer computing system 106 and the host computing system 102 can include, for example, the consumer computing system 106 being used to query a set of sensitive or other controlled data, access online financial services provided via the interactive computing environment, submit an online credit card application or other digital application to the host computing system 102 via the interactive computing environment, operating an electronic tool within an interactive computing environment provided by a host computing system 102 (e.g., a content-modification feature, an application-processing feature, etc.), or perform some other electronic operation within a computing environment.

For instance, a website or other interactive computing environment provided by a financial institution's host computing system 102 can include electronic functions for obtaining one or more financial services, such as loan application and management tools, credit card application and transaction management workflows, electronic fund transfers, etc. A consumer computing system 106 can be used to request access to the interactive computing environment provided by the host computing system 102, which can selectively grant or deny access to various electronic functions.

Based on the request, the host computing system 102 can collect data associated with the customer and execute a predictive response application 104, which can include a set of timing-prediction model code 130 that is generated with the development computing system 114. Executing the predictive response application 104 can cause the host computing system 102 to compute a risk indicator (e.g., a risk assessment score, a predicted time of occurrence for the target event, etc.). The host computing system 102 can use the risk indicator to instruct another device, such as a web server within the same computing environment as the host computing system 102 or an independent, third-party computing system in communication with the host computing system 102. The instructions can indicate whether to grant the access request of the consumer computing system 106 to certain features of the interactive computing environment.

For instance, if timing data (or a risk indicator derived from the timing data) indicates that a target entity is associated with a sufficient likelihood of a particular risk, a consumer computing system 106 used by the target entity can be prevented from accessing certain features of an interactive computing environment. The system controlling the interactive computing environment (e.g., a host computing system 102, a web server, or some combination thereof) can prevent, based on the threshold level of risk, the consumer computing system 106 from advancing a transaction within the interactive computing environment. Preventing the consumer computing system 106 from advancing the transaction can include, for example, sending a control signal to a web server hosting an online platform, where the control signal instructs the web server to deny access to one or more functions of the interactive computing environment (e.g., functions available to authorized users of the platform).

Additionally or alternatively, modifying the host system operation based on the computed time of the target can include causing a system that controls an interactive computing environment (e.g., a host computing system 102, a web server, or some combination thereof) to modify the functionality of an online interface provided to a consumer computing system 106 associated with the target entity. For instance, the host computing system 102 can use timing data (e.g., an adverse action timing prediction) generated by the timing-prediction model code 130 to implement a modification to an interface of an interactive computing environment presented at a consumer computing system 106. In this example, the consumer computing system 106 is associated with a particular entity whose predictor variable data is used to compute the timing data. If the timing data indicates that a target event for a target entity will occur in a given time period, the host computing system 102 (or a third-party system with which the host computing system 102 communicates) could rearrange the layout of an online interface so that features or content associated with a particular risk level are presented more prominently (e.g., by presenting online products or services targeted to the risk level), features or content associated with different risk levels are hidden, presented less prominently, or some combination thereof.

In various aspects, the host computing system 102 or a third-party system performs these modifications automatically based on an analysis of the timing data (alone or in combination with other data about the entity), manually based on user inputs that occur subsequent to computing the timing data with the timing-prediction model code 130, or some combination thereof. In some aspects, modifying one or more interface elements is performed in real time, i.e., during a session in which a consumer computing system 106 accesses or attempts to access an interactive computing environment. For instance, an online platform may include different modes, in which a first type of interactive user experience (e.g., placement of menu functions, hiding or displaying content, etc.) is presented to a first type of user group associated with a first risk level and a second type of interactive user experience is presented to a second type of user group associated with a different risk level. If, during a session, timing data is computed that indicates that a user of the consumer computing system 106 belongs to the second group, the online platform could switch to the second mode.

In some aspects, modifying the online interface or other features of an interactive computing environment can be used to control communications between a consumer computing system 106 and a system hosting an online environment (e.g., a host computing system 102 that executes a predictive response application 104, a third-party computing system in communication with the host computing system 102, etc.). For instance, timing data generated using a set of timing-prediction models could indicate that a consumer computing system 106 or a user thereof is associated with a certain risk level. The system hosting an online environment can require, based on the determined risk level, that certain types of interactions with an online interface be performed by the consumer computing system 106 as a condition for the consumer computing system 106 to be provided with access to certain features of an interactive computing environment. In one example, the online interface can be modified to prompt for certain types of authentication data (e.g., a password, a biometric, etc.) to be inputted at the consumer computing system 106 before allowing the consumer computing system 106 to access certain tools within the interactive computing environment. In another example, the online interface can be modified to prompt for certain types of transaction data (e.g., payment information and a specific payment amount authorized by a user, acceptance of certain conditions displayed via the interface) to be inputted at the consumer computing system 106 before allowing the consumer computing system 106 to access certain portions of the interactive computing environment, such as tools available to paying customers. In another example, the online interface can be modified to prompt for certain types of authentication data (e.g., a password, a biometric, etc.) to be inputted at the consumer computing system 106 before allowing the consumer computing system 106 to access certain secured datasets via the interactive computing environment.

In additional or alternative aspects, a host computing system 102 can use timing data generated by the timing-prediction model code 130 to generate one or more reports regarding an entity or a group of entities. In a simplified example, knowing when an entity, such as a borrower, is likely to experience a particular adverse action, such as a default, could allow a user of the host computing system 102 (e.g., a lender) to more accurately price certain online products, to predict time between defaults for a given customer and thereby manage customer portfolios, optimize and value portfolios of loans by providing timing information, etc.

Example of Using a Neural Network for Timing-Prediction Model

In some aspects, a timing-prediction model built for a given time bin (or other time period) can be a neural network model. A neural network can be represented as one or more hidden layers of interconnected nodes that can exchange data between one another. The layers may be considered hidden because they may not be directly observable in the normal functioning of the neural network.

A neural network can be trained in any suitable manner. For instance, the connections between the nodes can have numeric weights that can be tuned based on experience. Such tuning can make neural networks adaptive and capable of “learning.” Tuning the numeric weights can involve adjusting or modifying the numeric weights to increase the accuracy of a risk indicator, prediction of entity behavior, or other response variable provided by the neural network. Additionally or alternatively, a neural network model can be trained by iteratively adjusting the predictor variables represented by the neural network, the number of nodes in the neural network, or the number of hidden layers in the neural network. Adjusting the predictor variables can include eliminating the predictor variable from the neural network. Adjusting the number of nodes in the neural network can include adding or removing a node from a hidden layer in the neural network. Adjusting the number of hidden layers in the neural network can include adding or removing a hidden layer in the neural network.

In some aspects, training a neural network model for each time bin includes iteratively adjusting the structure of the neural network (e.g., the number of nodes in the neural network, number of layers in the neural network, connections between layers, etc.) such that a monotonic relationship exists between each of the predictor variables and the risk indicator, prediction of entity behavior, or other response variable. Examples of a monotonic relationship between a predictor variable and a response variable include a relationship in which a value of the response variable increases as the value of the predictor variable increases or a relationship in which the value of the response variable decreases as the value of the predictor variable increases. The neural network can be optimized such that a monotonic relationship exists between each predictor variable and the response variable. The monotonicity of these relationships can be determined based on a rate of change of the value of the response variable with respect to each predictor variable.

In some aspects, the monotonicity constraint is enforced using an exploratory data analysis of the training data. For example, if the exploratory data analysis indicates that the relationship between one of the predictor variables and an odds ratio (e.g., an odds index) is positive, and the neural network shows a negative relationship between a predictor variable and a credit score, the neural network can be modified. For example, the predictor variable can be eliminated from the neural network or the architecture of the neural network can be changed (e.g., by adding or removing a node from a hidden layer or increasing or decreasing the number of hidden layers).

Example of Using a Logistic Regression for Timing-Prediction Model

In additional or alternative aspects, a timing-prediction model built for a particular time bin (or other time period) can be a logistic regression model. A logistic regression model can be generated by determining an appropriate set of logistic regression coefficients that are applied to predictor variables in the model. For example, input attributes in a set of training data are used as the predictor variables. The logistic regression coefficients are used to transform or otherwise map these input attributes into particular outputs in the training data (e.g., predictor data samples 122 and response data samples 126).

Example of Using a Tree-Based Timing-Prediction Model

In additional or alternative aspects, a timing-prediction model built for a particular time bin (or other time period) can be a tree-based machine-learning model. For example, the model-development engine 116 can retrieve the objective function from a non-transitory computer-readable medium. The objective function can be stored in the non-transitory computer-readable medium based on, for example, one or more user inputs that define, specify, or otherwise identify the objective function. In some aspects, the model-development engine 116 can retrieve the objective function based on one or more user inputs that identify a particular objective function from a set of objective functions (e.g., by selecting the particular objective function from a menu).

The model-development engine 116 can partition, for each predictor variable in the set X, a corresponding set of the predictor data samples 122 (i.e., predictor variable values). The model-development engine 116 can determine the various partitions that maximize the objective function. The model-development engine 116 can select a partition that results in an overall maximized value of the objective function as compared to each other partition in the set of partitions. The model-development engine 116 can perform a split that results in two child node regions, such as a left-hand region R_{L} and a right-hand region R_{R}. The model-development engine 116 can determine if a tree-completion criterion has been encountered. Examples of tree-completion criterion include, but are not limited to: the tree is built to a pre-specified number of terminal nodes, or a relative change in the objective function has been achieved. The model-development engine 116 can access one or more tree-completion criteria stored on a non-transitory computer-readable medium and determine whether a current state of the decision tree satisfies the accessed tree-completion criteria. If so, the model-development engine 116 can output the decision tree. Outputting the decision tree can include, for example, storing the decision tree in a non-transitory computer-readable medium, providing the decision tree to one or more other processes, presenting a graphical representation of the decision tree on a display device, or some combination thereof.

Regression and classification trees partition the predictor variable space into disjoint regions, Rₖ (k=1, . . . K). (It is noted that any use of the variables k, K, j, J, n, or N in the following discussion of regression and classification trees provided herein with respect to Equations (15)-(29) is different from the use of the variables k, K, j, J, n, or N in the description of wavelet transforms discussed above.) Each region is assigned a representative response value βₖ. A decision tree T can be specified as:

$$T ( x ; Θ ) = {\sum }_{k = 1}^{K} {β}_{k} I ( x ∈ {R}_{k} ) \qquad ( 15 )$$

where Θ={Rₖ,βₖ}₁^{K}, 1(·)=1 if the argument is true and 0 otherwise, and all other variables previously defined. The parameters of Equation (15) are found by maximizing a specified objective function L:

$$\hat{Θ} = arg {max}_{Θ} {\sum }_{i = 1}^{n} L ( {y}_{i} , T ( {x}_{i} ; Θ ) ) \qquad ( 16 )$$

The estimates, \hat{R}ₖ, of \hat{Θ} can be computed using a greedy (i.e. choosing the split that maximizes the objective function), top-down recursive partitioning algorithm, after which estimation of βₖ is superficial (e.g., a \hat{β}ₖ=ƒ(yᵢ∈\hat{R}ₖ)).

A random forest model is generated by building independent trees using bootstrap sampling and a random selection of predictor variables as candidates for splitting each node. The bootstrap sampling involves sampling certain training data (e.g., predictor data samples 122 and response data samples 126) with replacement, so that the pool of available data samples is the same between different sampling operations. Random forest models are an ensemble of independently built tree-based models. Random forest models can be represented as:

$${F}_{M} ( x ; Ω ) = q {\sum }_{m = 1}^{M} {T}_{m} ( x ; {Θ}_{m} ) \qquad ( 17 )$$

where M is the number of independent trees to build, Ω={Θₘ}₁^{M}, and q is an aggregation operator or scalar (e.g., q=M⁻¹ for regression), with all other variables previously defined.

To create a random forest model, the model-development engine 116 can select or otherwise identify a number M of independent trees to be included in the random forest model. For example, the number M can be stored in a non-transitory computer-readable medium accessible to the model-development engine 116, can be received by the model-development engine 116 as a user input, or some combination thereof. The model-development engine 116 can select, for each tree from 1 . . . M, a respective subset of data samples to be used for building the tree. For example, for a given set of the trees, the model-development engine 116 can execute one or more specified sampling procedures to select the subset of data samples. The selected subset of data samples is a bootstrap sample for that tree.

The model-development engine 116 can execute a tree-building algorithm to generate the tree based on the respective subset of data samples for that tree. For instance, the model-development engine 116 can select, for each split in the tree building process, k out of p predictor variables for use in the splitting process using the specified objective function. The model-development engine 116 can combine the generated decision trees into a random forest model. For example, the model-development engine 116 can generate a random forest model F_{M} by summing the generated decision trees according to the function F_{M}(x;\hat{Ω})=qΣₘ₌₁^{M}Tₘ(x; \hat{Θ}ₘ). The model-development engine 116 can output the random forest model. Outputting the random forest model can include, for example, storing the random forest model in a non-transitory computer-readable medium, providing the random forest model to one or more other processes, presenting a graphical representation of the random forest model on a display device, or some combination thereof.

Gradient boosted machine models can also utilize tree-based models. The gradient boosted machine model can be generalized to members of the underlying exponential family of distributions. For example, these models can use a vector of responses, y={yᵢ}₁ⁿ, satisfying

y=μ+e (18)

and a differentiable monotonic link function F(·) such that

$${F}_{M} ( μ ) = {\sum }_{m = 1}^{M} {T}_{m} ( x ; {Θ}_{m} ) \qquad ( 19 )$$

where, m=1, . . . , M and Θ={Rₖ,βₖ}₁^{K}. Equation (19) can be rewritten in a form more reminiscent of the generalized linear model as

$${F}_{M} ( μ ) = {\sum }_{m = 1}^{M} {X}_{m} {β}_{m} \qquad ( 20 )$$

where, Xₘ is a design matrix of rank k such that the elements of the i^{th} column of Xₘ include evaluations of I(x∈Rₖ) and βₘ={β}₁^{k}. Here, Xₘ and βₘ represent the design matrix (basis functions) and corresponding representative response values of the m^{th} tree. Also, e is a vector of unobserved errors with E(μ)=0 and

cov(μ)=R_{μ} (21)

Here, R_{μ} is a diagonal matrix containing evaluations at μ of a known variance function for the distribution under consideration.
Estimation of the parameters in Equation (19) involves maximization of the objective function

$$\hat{Θ} = arg {max}_{Θ} {\sum }_{i = 1}^{n} L ( {y}_{i} ) , {\sum }_{m = 1}^{M} {T}_{m} ( {x}_{i} ; {Θ}_{m} ) \qquad ( 22 )$$

In some cases, maximization of Equation (22) is computationally expensive. An alternative to direct maximization of Equation (22) is a greedy stage-wise approach, represented by the following function:

$${\hat{Θ}}_{m} = arg {max}_{Θ} {\sum }_{i = 1}^{n} L ( {y}_{i} , {T}_{m} ( {x}_{i} ; {Θ}_{m} ) + v ) \qquad ( 23 )$$

### Thus,

Fₘ(μ)=Tₘ(x;Θₘ)+ν (24)

where, ν=Σⱼ₌₁^{m-1} Fⱼ(μ)=Σⱼ₌₁^{m-1}Tⱼ(x; Θⱼ).
Methods of estimation for the generalized gradient boosting model at the m^{th} iteration are analogous to estimation in the generalized linear model. Let \hat{Θ}ₘ be known estimates of Θₘ and \hat{μ} is defined as

\hat{μ}=Fₘ⁻¹[Tₘ(x;\hat{Θ}ₘ)+ν] (25)

Letting

z=Fₘ(\hat{μ})+Fₘ′(\hat{μ})(y−\hat{μ})−ν (26)

then, the following equivalent representation can be used:

z|Θₘ˜N[Tₘ(x;Θₘ),Fₘ′(\hat{μ})R_{\hat{μ}}Fₘ′(\hat{μ})] (27)

Letting Θₘ be an unknown parameter, this takes the form of a weighted least squares regression with diagonal weight matrix

Ŵ=R_{û}⁻¹[F′(\hat{μ})]⁻² (28)

Table 1 includes examples of various canonical link functions Ŵ=R_{\hat{μ}}.

TABLE 1

| Distribution | F(μ) | Weight |
|---|---|---|
| Binomial | log[μ/(1 − μ)] | μ(1 − μ) |
| Poisson | log(μ) | μ |
| Gamma | μ⁻¹ | μ⁻² |
| Gaussian | M | 1 |

The response z is a Taylor series approximation to the linked response F(y) and is analogous to the modified dependent variable used in iteratively reweighted least squares. The objective function to maximize corresponding to the model for z is

$$L ( {Θ}_{m} , R ; z ) = - \frac{1}{2} log log \vert ϕ V \vert - \frac{1}{2 ϕ} {( z - {T}_{m} ( x ; {Θ}_{m} ) )}^{T} {V}^{- 1} ( z - {T}_{m} ( x ; {Θ}_{m} ) ) - \frac{n}{2} log log ( 2 π ) \qquad ( 29 )$$

where, V=W^{-1/2}R_{μ}W^{-1/2} and ϕ is an additional scale/dispersion parameter. Estimation of the components in Equation (29) are found in a greedy forward stage-wise fashion, fixing the earlier components.

To create a gradient boosted machine model, the model-development engine 116 can identify a number of trees for a gradient boosted machine model and specify a distributional assumption and a suitable monotonic link function for the gradient boosted machine model. The model-development engine 116 can select or otherwise identify a number M of independent trees to be included in the gradient boosted machine model and a differentiable monotonic link function F(·) for the model. For example, the number M and the function F(·) can be stored in a non-transitory computer-readable medium accessible to the model-development engine 116, can be received by the model-development engine 116 as a user input, or some combination thereof.

The model-development engine 116 can compute an estimate of μ, \hat{μ} from the training data or an adjustment that permits the application of an appropriate link function (e.g. \hat{μ}=n⁻¹Σᵢ₌₁ⁿ yᵢ), and set ν₀=F₀(\hat{μ}), and define R_{\hat{μ}}. The model-development engine 116 can generate each decision tree using an objective function such as a Gaussian log likelihood function (e.g., Equation 15). The model-development engine 116 can regress z to x with a weight matrix Ŵ. This regression can involve estimating the Θₘ that maximizes the objective function in a greedy manner. The model-development engine 116 can update νₘ=νₘ₋₁+Tₘ(x;\hat{Θ}ₘ) and setting \hat{μ}=Fₘ⁻¹(νₘ). The model-development engine 116 can execute this operation for each tree. The model-development engine 116 can output a gradient boosted machine model. Outputting the gradient boosted machine model can include, for example, storing the gradient boosted machine model in a non-transitory computer-readable medium, providing the gradient boosted machine model to one or more other processes, presenting a graphical representation of the gradient boosted machine model on a display device, or some combination thereof.

In some aspects, the tree-based machine-learning model for each time bin is iteratively adjusted to enforce monotonicity with respect to output values associated with the terminal nodes of the decision trees in the model. For instance, the model-development engine 116 can determine whether values in the terminal nodes of a decision tree have a monotonic relationship with respect to one or more predictor variables in the decision tree. In one example of a monotonic relationship, the predicted response increases as the value of a predictor variable increases (or vice versa). If the model-development engine 116 detects an absence of a required monotonic relationship, the model-development engine 116 can modify a splitting rule used to generate the decision tree. For example, a splitting rule may require that data samples with predictor variable values below a certain threshold value are placed into a first partition (i.e., a left-hand side of a split) and that data samples with predictor variable values above the threshold value are placed into a second partition (i.e., a right-hand side of a split). This splitting rule can be modified by changing the threshold value used for partitioning the data samples.

A model-development engine 116 can also train an unconstrained tree-based machine-learning model by smoothing over the representative response values. For example, the model-development engine 116 can determine whether values in the terminal nodes of a decision tree are monotonic. If the model-development engine 116 detects an absence of a required monotonic relationship, the model-development engine 116 can smooth over the representative response values of the decision tree, thus enforcing monotonicity. For example, a decision tree may require that the predicted response increases if the decision tree is read from left to right. If this restriction is violated, the predicted responses can be smoothed (i.e., altered) to enforce monotonicity.

Examples of Handling Missing Time Series Information when Using Wavelets to Create New Attributes from Time-Series Data

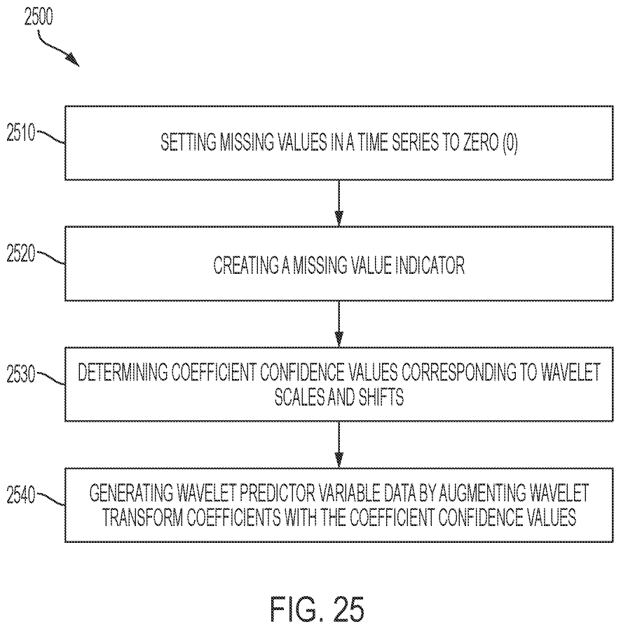

In certain cases, time series data from which wavelet coefficients are created may have missing time-series information. FIG. 25 depicts an example of a process 2500 for handling missing time series information when using wavelets to create new attributes from time-series data, according to certain embodiments disclosed herein. For illustrative purposes, the process 2500 is described with reference to implementations described with respect to various examples depicted in FIG. 1. Other implementations, however, are possible. The operations in FIG. 25 can be implemented in program code that is executed by one or more computing devices, such as the development computing system 114, the host computing system 102, or some combination thereof. In some aspects of the present disclosure, one or more operations shown in FIG. 25 may be omitted or performed in a different order. Similarly, additional operations not shown in FIG. 25 may be performed.

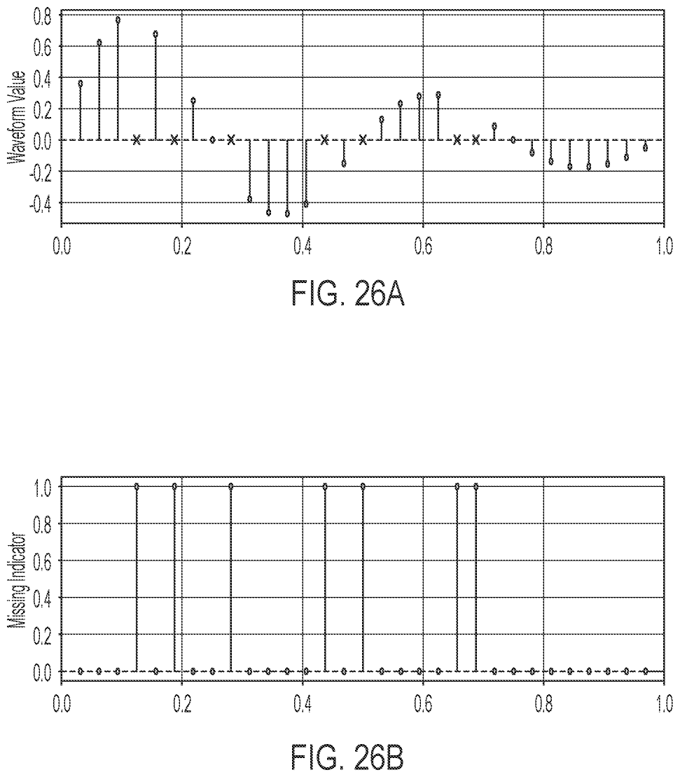

In block 2510, the process 2500 involves setting missing values in a time series to zero (0). In some examples, a time-series to be input to the timing-prediction model must include a value at each time instance over a series of time instances (e.g. weekly time instances over a total time of 32 weeks). In some instances, the time series has one or more missing values for particular time instances of the series of time instances. The host computing system 102 can implement block 2510 by receiving or otherwise accessing the time-series to be input to the timing-prediction model and can detect one or more time instances for which values are missing. FIG. 26(a) depicts an example of a time series in which missing values are detected. In certain examples, the time-series is generated from raw panel data, as described herein in FIGS. 8, 9, 10(a), 10(b), 11, and 12. In some examples, the host computing system 102 can set a value of zero (0) for any time instances the time series that have missing values.

In block 2520, the process 2500 involves creating a missing value indicator. The host computing system 102 can generate the missing data value indicator by assigning, for each time instance of the time series, a value of one (1) to time instances that are missing data values and a value of zero (0) to time instances that have data values. FIG. 26(b) depicts generating a missing indicator based on the time series of FIG. 26(a), according to certain embodiments disclosed herein.

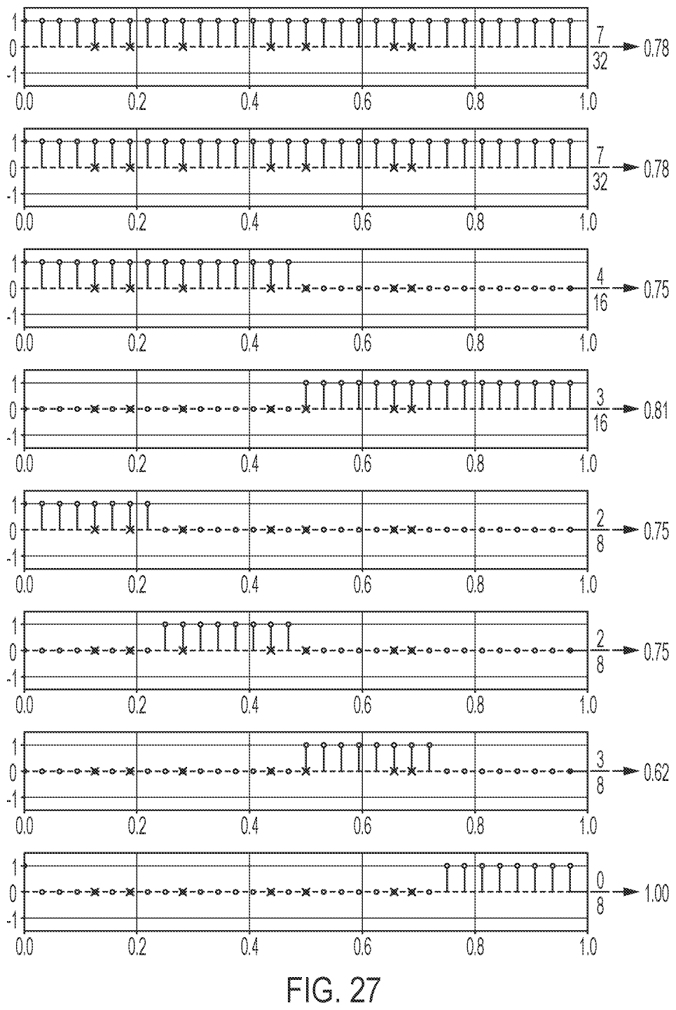

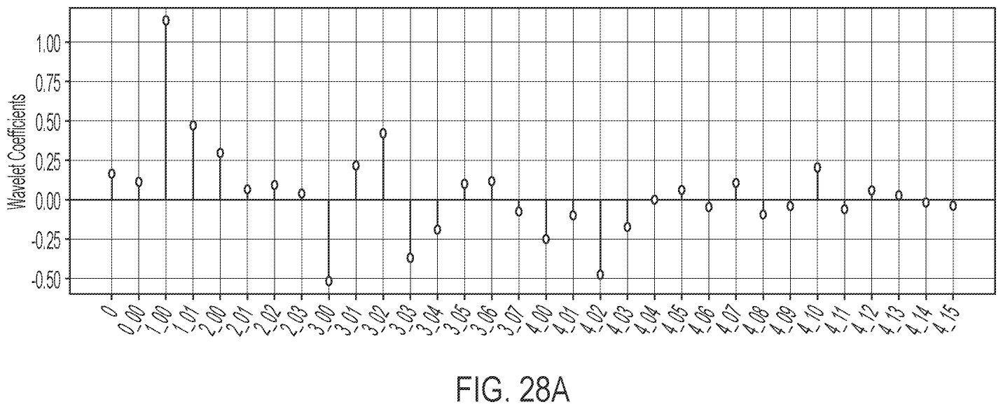

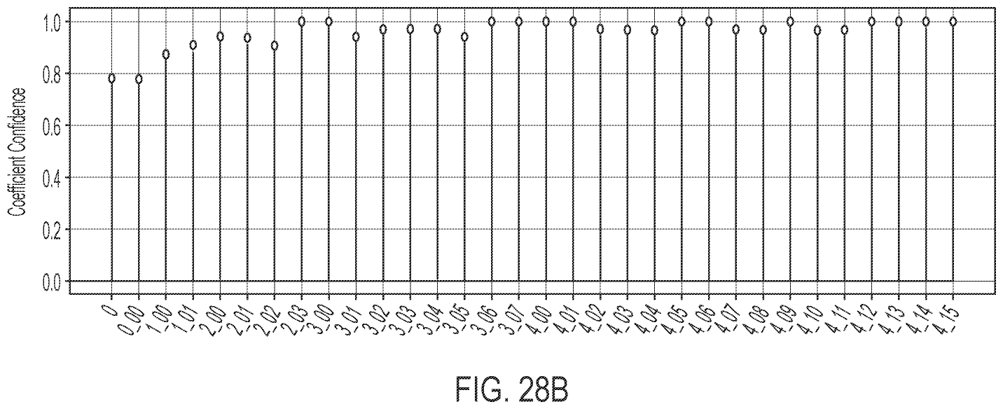

In block 2530, the process 2500 involves determining coefficient confidence values corresponding to wavelet scales and shifts. The host computing system 102 may create summation operations that cover windows of time corresponding to the scale and shift of the wavelet transform applied to the time series waveform (e.g., the time series waveform of FIG. 11). In some examples, a summation operation is an inner product of operators given in the missing value indicator. For example, the summation operation is an inner product of a set of operators with constant value of 1 over various scales and shifts (with a value of 0 otherwise) with the missing value indicator, as shown in FIG. 27. The summation operations may be independent of the type of wavelet transform applied, and may depend only on the scale and shift of their corresponding wavelets. The host computing system 102 can determine a fraction for each window, where the numerator of the fraction is the resulting summation and the denominator of the fraction indicates the number of non-zero values in the corresponding wavelet transform. The host computing system 102 can subtract the fractions from one (1) to yield coefficient confidence values that correspond to the wavelet coefficients for the time series data. FIG. 27 depicts summation operations for several wavelets with missing values, according to certain embodiments disclosed herein. FIG. 28(a) depicts wavelet coefficients determined by applying a Haar Wavelet Transform to the time-series of FIG. 26(a), according to certain aspects disclosed herein. FIG. 28(b) depicts coefficient confidence values computed based on summations determined in FIG. 27 and which correspond to the wavelet coefficients of FIG. 28(a), according to certain embodiments disclosed herein.

In block 2540, the process 2500 involves generating wavelet predictor variable data by augmenting the wavelet transform coefficients with the coefficient confidence values. The host computing system 102 can apply the timing-prediction model to the set of attributes. In certain examples, the set of attributes is input to the model. For example, the host computing system 102 can compute a set of probabilities for a target event by executing the predictive response application 104, which can include program code outputted by a development computing system 114. Executing the program code can cause one or more processing devices of the host computing system 102 to apply the set of timing-prediction models, which have been trained with the development computing system 114, to the wavelet predictor variable data. For instance, the host computing system 102 can apply the set of timing prediction models to the shift values corresponding to different scales to determine a set of probabilities for the set of timing prediction models. The host computing system 102 can also compute, from the set of probabilities, a time of a target event (e.g., an adverse action or other event of interest). In another example, the host computing system 102 can apply the set of timing prediction models to each set of shift values (corresponding to each scale) to determine a set of scale-specific probabilities corresponding to the number of scales in the wavelet predictor variable data. The host computing system 102 can determine a set of combined probabilities as a function of the set of scale-specific probabilities for the set of timing prediction models. For instance, an average, a weighted average, a median, or other function may be applied to a particular set of scale-specific probabilities for a particular timing prediction model (of the set of timing prediction models) to determine a particular combined probability (of the set of combined probabilities). The host computing system 102 can also compute, from the set of combined probabilities, a time of a target event (e.g., an adverse action or other event of interest).

Further, the host computing system 102 can modify a host system operation based on the computed time of the target event. For instance, the time of a target event can be used to modify the operation of different types of machine-implemented systems within a given operating environment.

FIG. 26(a) depicts a time series with missing values, according to certain embodiments disclosed herein. FIG. 26(a) represents the time series in graphical form with the x-axis representing a series of time instances normalized between 0 and 1, and the y-axis representing a waveform value at each of the time instances with a value between −0.5 and 0.8. The time series may be represented in other formats, for example, in a table, matrix, or other data structure or representation. As shown in FIG. 26(a), the time-series is missing values at the time instances indicated with an “x.”

FIG. 26(b) depicts generating a missing indicator based on the time series of FIG. 26(a), according to certain embodiments disclosed herein. As shown in FIG. 26(b), each time instance at which a missing data value was detected in the time series of FIG. 26(a) (indicated with an x in FIG. 26(a)) is assigned a value of 1 and each time instance at which the time series of FIG. 26(a) had a value is assigned a value of 0.

FIG. 27 depicts summation operations for several wavelets with missing values, according to certain embodiments disclosed herein. As shown in FIG. 27, summation operations over windows corresponding to wavelet scales and shifts may be applied to the missing value indicator. In FIG. 27, missing values are indicated with an “x.” In FIG. 27, a resulting summation is shown to the right of the figure as the numerator of a fraction whose denominator indicates the number of non-zero values in the corresponding wavelet transform.

FIG. 28(a) depicts wavelet coefficients determined by applying a Haar Wavelet Transform to the time-series of FIG. 26(a).FIG. 28(b) depicts coefficient confidence values computed based on summations determined in FIG. 27 and which correspond to the wavelet coefficients of FIG. 28(a).

Explanatory Data Generation for Wavelet Based Models

Explanatory data can be generated from a wavelet based model, such as the timing-prediction model or set of timing-prediction models described above, using any appropriate method described herein. An example of explanatory data is a reason code, adverse action code, or other data indicating an impact of a given variable on a predictive output. For instance, explanatory reason codes may indicate why an entity received a particular predicted output (e.g. an adverse event prediction in a timing-prediction model). The explanatory reason codes can be generated from a wavelet based model to satisfy suitable requirements. Examples of these rules include explanatory requirements, business rules, regulatory requirements, etc.

In some examples described herein, a group of wavelet coefficients is computed for each traditional modeling attribute associated with each entity through applying a wavelet transform to a set of time-lagged values of the given attribute. Generating input data through applying wavelet transforms can allow the wavelet based model to consider temporal effects of different attributes and the changing impact of these attributes over various lengths and locations of time. Using a traditional modeling attribute, a set of wavelets (e.g. 32 wavelets or other predefined number of wavelets) may be utilized to generate wavelet coefficients for the wavelet based model. Each wavelet measures the effect of a specific time frame of the time-series data to which the model is applied. For example, FIG. 11 depicts time frames used to construct example Haar wavelets. For example, in FIG. 11, the top row depicts a first wavelet, which measures the mean value across the entire time span (32 months) for an attribute. The second row shows construction of a second wavelet, which measures the difference between average of the most recent 16 months values for of the attribute and the average for the furthest 16 months values of the attribute. The time frames can continue to be divided in half with successive wavelets constructed for each shorter half-length, until the final 16 wavelets comprise measurements of the difference between 16 successive non-overlapping two-month windows. In the figure above, solid grey indicates a value of zero.

For example, using the wavelet coefficients, a set of predictor attributes can be constructed that allow the investigation of influences on an entity's likelihood to experience a particular output of the wavelet based model (e.g., an adverse event in a timing-prediction model) over longer spans of time than normally considered by wavelet based models (e.g. adverse event prediction models, risk models, etc.). This process also allows for information to be captured within smaller time frames leading to more predictive wavelet based models while still meeting any prescribed regulatory requirements that are applicable to the wavelet based models. For example, in a wavelet based model that considers data over a full time span of 32 months, smaller time frames encompassing 21, 22, 23, 24, 25, or other number of months less than the full time span may be considered.

In some cases, in a final version of a wavelet based model, not all wavelets describing particular behaviors may appear. For instance, in a test model using four sets of 32 wavelets built to demonstrate the ability to generate explainable predictions, 50 of the set of 128 wavelets could remain in the final model. In certain examples, non-overlapping Haar wavelets may be used. However, overlapping (correlated) wavelets could also be used.

Using the wavelets, host computing system 102 (or another system such as the development computing system 114) generates parameter values for each wavelet coefficient. The wavelet coefficients are normalized to account for the length of time over which wavelets are constructed. Instead of a single attribute reported at one point in time, such as the number of open accounts, or an attribute that measures a trend over a relatively short period of time, the wavelet coefficients represent time series information unique to each entity (e.g., consumer) that varies over a long period of time—for example, 32 months. The time frame could be extended or shortened as appropriate.

The wavelet based model (e.g. risk model) can be built using acceptable procedures, such as logistic regression, monotonic neural network or any other method capable of generating numerical results. The result is a set of parameter values associated with the included wavelets. The set of parameter values is then scored to produce an entity's original wavelet model output. Exploratory data analysis (EDA) can be conducted on the original attributes and the wavelets examining the bivariate relationship with the response variable as well as descriptive statistics. Descriptive statistics could be a minimum, a maximum, a mean, or other statistical function. The wavelet based model determines the direction of effect of each original attribute and each wavelet with respect to the output (e.g. a probability of an adverse event). The observed direction of effect in the bivariate analysis can be preserved in the multivariate model. In effect, the collective impact of the wavelets on wavelet model output reflect the original attribute's direction of effect with regard to wavelet model output.

Wavelet coefficients are constructed without missing values. If missing values exist, they can be reassigned to a value with a similar bad rate or odds index. Wavelet coefficients can be capped and floored at the desired upper and lower percentile levels. For example, the 99th percentile and 11th percentiles, respectively, can be used. Once the data are prepared for analysis, various variable selection methods can be used such as a forward, backwards, or stepwise selection. In some examples, the chosen variable selection method ensures that the wavelets retained in the final wavelet based model are statistically significant and agree with the bivariate relationship within the EDA. Furthermore, the final wavelet based model can be a reasonable variance inflation factor. A wavelet based model using wavelets with parameter values that are statistically significant and in agreement with the EDA can produce the output of the entity.

In the following sections, several approaches for model explanations are described. In some instances, regulatory requirements (e.g. in the United States) mandate that in the case of credit denial, a predictive model must be able to generate a consumer-level explanation indicating why adverse action was taken. The approaches described herein can be used to generate such consumer-level explanations.

Approaches described herein for model explanations of wavelet based models include a points below maximum approach, an Integrated Gradients approach, and a Shapley Values approach. Each of the these approaches can be applied to any wavelet-based models including, for example, the timing-prediction model discussed above.

Example of Generating Explanatory Data Using a Points Below Max Approach

In some aspects, a reason code or other explanatory data may be generated using a “points below max” approach or a “points for max improvement” approach. A reason code indicating an effect or an amount of impact that a given independent variable has on the value of the predicted response. The independent variable values that maximize the function F(x; β) that presents the model used for prediction can be determined using the monotonicity constraints that were enforced in model development. For example, let xᵢ*(i=1, . . . , n) be the right endpoint of the domain of the independent variable xᵢ. Then, for a monotonically increasing function, the output function is maximized at F(x*; β), where β is the set of all parameters associated with the model and all other variables previously defined. A “points below max” approach determines the difference between, for example, an idealized output and a particular entity (e.g. subject, person, or object) by finding values of one or more independent variables that maximize F(x; β).

Reason codes for the independent variables may be generated by rank ordering the differences obtained from either of the following functions:

F(x₁*,x₂*, . . . xᵢ*, . . . xₙ*;β)−F(x₁*,x₂*, . . . xᵢ*, . . . xₙ*;β) (30)

F(x₁*, . . . xᵢ*, . . . xₙ*;β)−F(x₁*, . . . xᵢ*, . . . xₙ*;β) (31)

In these examples, the first function (30) can be used for a “points below max” approach and the second function (31) can be used for a “points for max improvement” approach. For a monotonically decreasing function, the left endpoint of the domain of the independent variables can be substituted into xⱼ*.

In the example of a “points below max” approach, a decrease in the output function for a given entity may be computed using a difference between the maximum value of the output function using x* and the decrease in the value of the output function given x. In the example of a “points for max improvement” approach, a decrease in the output function may be computed using a difference between two values of the output function. In this case, the first value may be computed using the output-maximizing value for xⱼ* and a particular entity's values for the other independent variables. The decreased value of the output function may be computed using the particular entity's value for all of the independent variables xᵢ.

As a specific example, in the case of logistic regression, the “points for max improvement” equation leads to β(xᵢ*−xᵢ), which is computed for all n attributes in the wavelet based model. In this example, the output of the wavelet based model (e.g. an adverse action prediction) may be solely dependent on how much an individual's attribute value (xᵢ) varies from its maximum value (xᵢ*) and whether the attribute influences the final score in an increasing or decreasing manner. This example shows that attributes xᵢ in certain risk-modeling schemes should have a monotonic relationship with the dependent variable y, and the bivariate relationship between each xᵢ and y observed in the raw data be preserved in the model.

Example of Generating Explanatory Data for Wavelet-Based Models Using a Points Below Max Approach

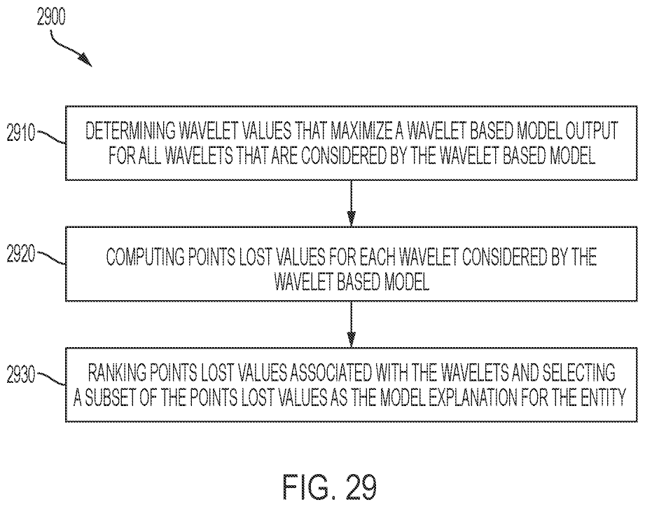

FIG. 29 depicts an example of a process 2900 for generating explanatory data for a wavelet based model, according to certain aspects disclosed herein. For illustrative purposes, the process 2900 is described with reference to implementations described with respect to various examples depicted in FIG. 1. Other implementations, however, are possible. The operations in FIG. 29 are implemented in program code that is executed by one or more computing devices, such as the development computing system 114, the host computing system 102, or some combination thereof. In some aspects of the present disclosure, one or more operations shown in FIG. 29 may be omitted or performed in a different order. Similarly, additional operations not shown in FIG. 29 may be performed.

In block 2910, the process 2900 involves determining wavelet values to maximize a wavelet based model output for all wavelets that are considered. In order to identify a reason code, the wavelet values that maximize the model score for all wavelets being simultaneously considered are noted and obtained. For example, the host computing system 102 determines, for each Haar wavelet used by the model, a wavelet value that maximizes a score. In certain embodiments, instead of considering a full set of wavelets (e.g. 128 wavelets) that represent a time series, the wavelet based model can consider a reduced subset of the full set of wavelets (e.g. 50 wavelets) and the host computing system 102 can determine a wavelet value for each wavelet of the reduced subset that provides a maximum score. In an example, the maximum score is a theoretical maximum value for the score. In another example, the maximum score is a highest score of a set of actual scores associated with entities.

For example, the maximum possible score can be computed as:

Y_{Max}=α+β₁ω_{01Max}+β₂ω_{11Max}+ . . . +βₙω_{k1Max} (32)

where ω_{01Max} represents a maximum point generating value for wavelet 0 and attribute 1, which measures a mean value of the attribute across the entire time span (e.g. 32 months). In Equation (32), ω_{11Max} represents the maximum point generating value for wavelet 1 and attribute 1, which measures the difference in mean values for the most recent 2⁴ (16) months from which is subtracted the difference in mean value for the furthest 2⁴ (16) months, and so on. In Equation (32), the output for Y_{Max} is the theoretical maximum score attainable with the wavelet based model for all wavelet coefficients. As shown in FIG. 11, each non-overlapping wavelet is constructed to span the entire temporal data set (e.g. 32 months) with increasingly shorter time intervals.

In block 2920, the process 2900 involves computing points lost. For example, to compute points lost using points below maximum, a difference between the maximum possible score and the score an entity attains where one wavelet can be held at the entity's value while all other wavelets are kept at the maximum value can be calculated according to the following equation:

Yᵢ=α+β₁ω₀₁+β₂ω_{11Max}+ . . . +βₙω_{k1Max} (33)

where ω₀₁ represents the entity's value for wavelet 0 and attribute 1, which measures the mean value of the attribute across the entire time span (e.g. 32 months). The remaining wavelets can be held at their respective maximum values and the entity's score is computed. This process may be repeated for each wavelet to derive points lost for each wavelet. Then the points lost (points below maximum) for the wavelet can be determined as follows:

Points lost=Y_{Max}−Yᵢ (34)

for a wavelet i. In certain embodiments, a points lost value may be determined for every wavelet used in the wavelet based model. In certain examples, a points lost value is determined for each group of wavelets produced for each of the attributes considered by the wavelet based model.

In block 2930, the process 2900 involves ranking the points lost values associated with the wavelets and selecting a subset of the points lost values as a model explanation for the entity being evaluated. For example, a predefined number (e.g. four, five, or other number) of the points lost values can be selected. This process can be conducted on a wavelet by wavelet basis, or as shown here, over the entire series of wavelets derived from one attribute. By conducting these computations over the entire set of wavelets, an output of the wavelet based model can be determined. The host computing system 102 can return output notices (e.g. notice of an adverse action) that provide the entity of notice of the output of the wavelet based model in accordance with any applicable regulatory requirements. The host computing system 102 can output a reason code based on the selected predefined number of the points lost values. For example, a wavelet coefficient is selected that represents the average number of inquiries over a 32 month window and the reason code provided to the customer or entity is “too many inquiries.” In some examples, all of the points lost values associated with the wavelets are provided as the model explanation for the entity.

Example of Generating Explanatory Data Generated for Wavelet-Based Models Using an Integrated Gradients Approach

A reason code or other explanatory data may be generated using an integrated gradients approach. For example, an integrated gradients approach assigns a share of responsibility for a change in output of the wavelet based model Δƒ=ƒ(x)−ƒ(x′) between two sets of attribute values x′=(x₁′, . . . , xₖ′) (the baseline) and x=(x₁, . . . , xₖ) (the input) to each of the k individual attributes, in such a way that the sum of the responsibilities IGₖ is the total change in output Δƒ.

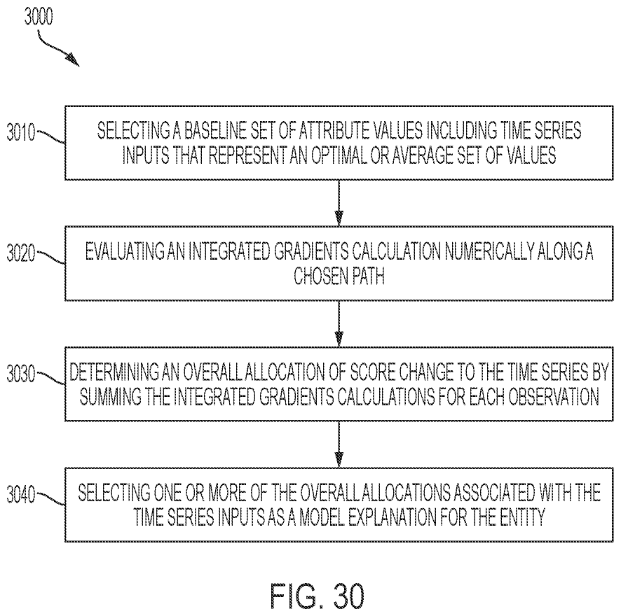

FIG. 30 depicts an example of a process 3000 for determining allocations of wavelet model output values using an integrated gradients approach, according to certain aspects disclosed herein. For illustrative purposes, the process 3000 is described with reference to implementations described with respect to various examples depicted in FIG. 1. Other implementations, however, are possible. The operations in FIG. 30 can be implemented in program code that is executed by one or more computing devices, such as the development computing system 114, the host computing system 102, or some combination thereof. In some aspects of the present disclosure, one or more operations shown in FIG. 30 may be omitted or performed in a different order. Similarly, additional operations not shown in FIG. 30 may be performed.

In block 3010, the process 3000 involves selecting a representative baseline set of attribute values x′ including time series inputs, that represents either an optimal or average set of values. In some examples, baseline values for time series inputs may be selected from available data to ensure feasibility of the whole time series. To explain an output of the wavelet based model in the negative (e.g. a refusal of credit), the baseline set of attribute values x′ can be chosen to be a representative “good” set of attribute values. The baseline may be chosen separately for each explanation by finding a set of attribute values close to the input values x but with a score that would lead to a positive decision. In another example, a single baseline may be chosen and used for all explanations. In this other example, all attribute values may be set individually to attribute values that maximize the wavelet based model output.

In block 3020, the process 3000 involves evaluating an integrated gradients calculation numerically along a chosen path. In some examples, the chosen path could be a straight line path, in attribute space from the baseline values x′ to the given input values x, taking account of the partial derivatives of any derived functions of the time series inputs that enter the output function. For example, the formulation of the integrated gradients approach depends upon a path λ(s) from λ(0)=x′ to λ(1)=x in an attribute space. The default choice may be the straight line path λ(s)=x′+s(x−x′), but other paths may be chosen resulting in path integrated gradients. The Integrated Gradients function for the k-th attribute is given by the integral:

$${IG}_{k} ( λ ) = {\int }_{0}^{1} \frac{\partial f}{\partial {λ}_{k}} \frac{d {λ}_{k}}{ds} ds \qquad ( 35 )$$

where, in the straight line case,

$$\frac{{dλ}_{k}}{ds}$$

is constant and this can be re-expressed as:

$${IG}_{k} = ( {x}_{k} - {x}_{κ}^{′} ) {\int }_{0}^{1} \frac{\partial f}{\partial {x}_{k}} {\vert}_{{x}^{′} + s ( x - {x}^{′} )} ds = ( {x}_{k} - {x}_{k}^{′} ) {\int }_{0}^{1} {( ∇ f )}_{k} ds \qquad ( 36 )$$

The integral can be evaluated numerically, simply by calculating the gradient ∇ƒ at equally spaced points along the path:

$${IIG}_{k} \approx ( {x}_{k} - {x}_{k}^{′} ) \frac{1}{m} {\sum }_{k = 1}^{m} \frac{\partial f}{\partial {x}_{k}} {\vert}_{{x}^{′} + \frac{k}{m} ( x - {x}^{′} )} = ( {x}_{k} - {x}_{k}^{′} ) \frac{1}{m} {\sum }_{i = 1}^{m} {( ∇ f )}_{i} ( {x}^{′} + \frac{k}{m} ( x - {x}^{′} ) ) \qquad ( 37 )$$

For a differentiable model, such as a neural network, the gradient may generally be calculated directly. For a non-differentiable model, such as a tree based model, it may be necessary to estimate the gradient numerically. In either case, the sum of the numerical calculations may be checked to determine whether the sum is approximately equal to the overall change in score. If not, the number of sampling points m may be increased.

In block 3030, the process 3000 involves determining an overall allocation of wavelet based model output change to the time series for each time series input by summing the integrated gradients calculations for each observation.

Applying an integrated gradients approach to wavelet based models with time series inputs may present challenges. In some instances, time series input is represented not by one single model variable but by a series of observations x=(xₜ,t∈T). However, in some approaches, the assigned responsibility in the explanatory data for the wavelet based model output change are not assigned to each individual observation xₜ, but rather to the whole time series x. In some instances, individual observations xₜ in a time series may be highly correlated, and setting each of them separately to an optimal value may produce a baseline for the overall time series that is not feasible or not represented in data. In some instances, a time series x=(xₜ, t∈T) may not enter the wavelet based model output function ƒ directly through the observations xₜ, but through one or more derived functions or operators g(x)=g((xₜ)) and the integrated gradient calculation must be adjusted accordingly. The proposed approach described herein addresses each of these example instances described above.

To address instances where time series input is represented not by one single model variable but by a series of observations, a responsibility for a wavelet based model output change assigned to a time series input x may be determined as the sum of the responsibilities assigned to the individual observations xₜ. That is, for a time series input x=(xₜ, t∈T):

$${IG}_{χ} = {\sum }_{t ∈ T} {IG}_{{x}_{t}} \qquad ( 38 )$$

Equation (38) preserves a property that the sum of responsibilities is equal to the overall change in score. To address instances where a time series may be highly correlated, an optimal value of the time series x=(xₜ,t∈T) may be chosen as a baseline as a whole, rather than choosing an optimal value for each xₜ. If the time series variable is strictly non-negative and a positive indicator of an output value (e.g. a risk such as past due amount) then an optimal value for the time series may consist of all zeroes. If the time series is a negative indicator of output value, then a representative optimal value for the time series with high values at every time point may be selected from data. To address instances where time series is input through one or more derived functions or operators, if the score function ƒ is expressed as ƒ(g₁(x), . . . , gₙ(x), . . . ) where g₁, . . . , gₙ are functions of the time series x=(xₜ, t∈T) and other terms do not depend on x, then the integrated gradients may be determined using the chain rule as follows:

$${IG}_{{x}_{t}} = ( {x}_{t} - {x}_{t}^{′} ) {\int }_{0}^{1} \frac{\partial f}{\partial {x}_{t}} ds = ( {x}_{t} - {x}_{t}^{′} ) {\sum }_{i = 1}^{n} {\int }_{0}^{1} \frac{\partial f}{\partial {g}_{i}} \frac{\partial {g}_{i}}{\partial {x}_{t}} ds \qquad ( 39 )$$

where implicitly the partial derivatives are evaluated at λ(s)=x′+s(x−x′). If all the operators gᵢ are affine, then their partial derivatives are constant and may be removed from the integral as follows:

$${IG}_{{x}_{t}} = ( {x}_{t} - {x}_{t}^{′} ) {\sum }_{i = 1}^{n} \frac{\partial {g}_{i}}{\partial {x}_{t}} {\int }_{0}^{1} \frac{\partial f}{\partial {g}_{i}} ds \qquad ( 40 )$$

Either of Equations (39) and (40) may be evaluated numerically by calculating the partial derivatives

$$\frac{\partial f}{\partial {g}_{i}} and \frac{\partial {g}_{i}}{\partial {x}_{t}}$$

at points along the path λ(s)=x′+s(x−x′).

The calculation can be simplified further when obtaining a total Integrated Gradients contribution for time series x, and the operators gᵢ are all affine. Returning to the original expression for Integrated Gradients as a path integral:

$${IIG}_{x} = {\sum }_{t ∈ T} {IG}_{{x}_{t}} = {\sum }_{t ∈ T} {\int }_{0}^{1} \frac{\partial f}{\partial {λ}_{{x}_{t}}} \frac{d {λ}_{{x}_{t}}}{ds} ds = {\sum }_{t ∈ T} {\sum }_{i = 1}^{n} {\int }_{0}^{1} \frac{\partial f}{\partial {g}_{i}} \frac{\partial {g}_{i}}{\partial {λ}_{{x}_{t}}} \frac{d {λ}_{{x}_{t}}}{ds} ds = {\sum }_{i = 1}^{n} {\int }_{0}^{1} \frac{\partial f}{\partial {g}_{i}} \frac{\partial {g}_{i}}{\partial s} ds \qquad ( 41 )$$

Equation (41) is the sum of the expressions for Path Integrated Gradients for each operator gᵢ, along the straight line path λ(s)=x′+s(x−x′) in the time series space. But if the operators are affine, this also yields a straight line path from (g₁(x′), . . . , gₙ(x′)) to (g₁(x), . . . , gₙ(x)) in the space of operator values, so this is in fact regular Integrated Gradients calculated in terms of the operator values:

$${IG}_{x} = {\sum }_{i = 1}^{n} {IG}_{{g}_{i}} \qquad ( 42 )$$

Accordingly, if affine transformations of the raw time series are used as inputs to a model (which includes the case of wavelets), Integrated Gradients may be calculated correctly for the time series by applying the Integrated Gradients calculation to the transformed inputs.

In block 3040, the process 3000 involves selecting one or more of the overall allocations associated with the time series inputs as a wavelet based model output explanation for the entity. For example, an overall allocation is selected that represents the average number of inquiries over a 32 month window and the reason code provided to the customer or entity is “too many inquiries.” In certain embodiments, all of the determined overall allocations are provided to the entity in the explanatory data.

In certain examples, applying integrated gradients to generate model explanations for models with time series inputs includes selecting a representative baseline set of attribute values x′ including time series inputs, that represents either an optimal or average set of values. Baseline value for time series inputs may be selected from available data to ensure feasibility of the whole time series. Applying integrated gradients to generate model explanations for models with time series inputs can include evaluating the integrated gradients calculation numerically along a chosen path, such as a straight line path, in attribute space from the baseline values x′ to the given input values x, taking account of the partial derivatives of any derived functions of the time series inputs that enter the score function. Applying integrated gradients to generate model explanations for models with time series inputs can include, for each time series input x=(xₜ, t∈T), summing the integrated gradients calculations for each observation xₜ to produce an overall allocation of score change to the time series x. In certain examples, if a time series input enters the model only through affine transformations, such as wavelets, then (1) evaluating the integrated gradients calculation numerically along a chosen path and (2) for each time series input, summing the integrated gradients calculations for each observation may be carried out in terms of the transformed variables instead of the raw time series values.

Example of Explanatory Data Generated for Wavelet Based Models Using a Shapley Values Approach

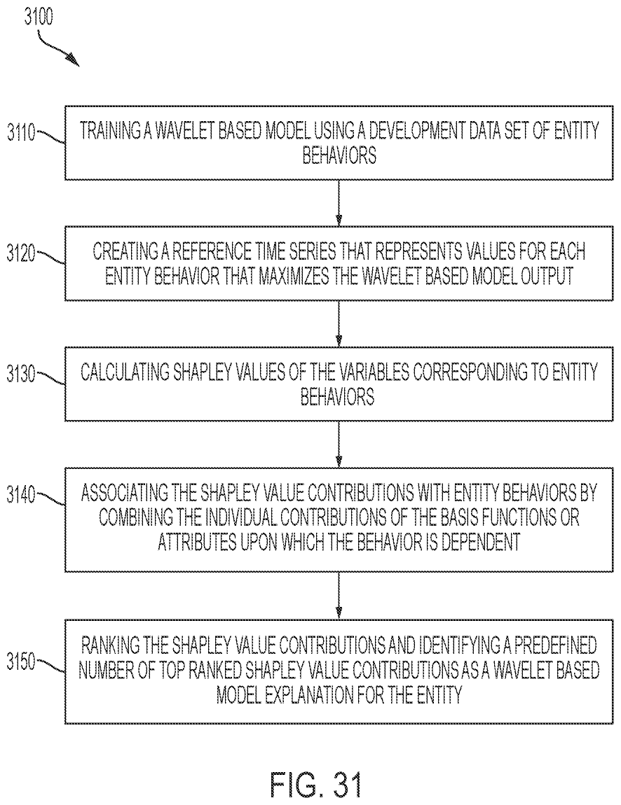

In some examples, a reason code or other explanatory data may be generated for a wavelet based model output using a Shapley values approach. Shapley values are a pay-off concept from cooperative game theory. Instead of players in a multi-player game cooperating to generate a pay-off, attributes within a model generate predictions. FIG. 31 depicts an example of a process 3100 for determining Shapley value contributions for a timing prediction model, according to certain embodiments disclosed herein. For illustrative purposes, the process 3100 is described with reference to implementations described with respect to various examples depicted in FIG. 1. Other implementations, however, are possible. The operations in FIG. 31 can be implemented in program code that is executed by one or more computing devices, such as the development computing system 114, the host computing system 102, or some combination thereof. In some aspects of the present disclosure, one or more operations shown in FIG. 31 may be omitted or performed in a different order. Similarly, additional operations not shown in FIG. 31 may be performed.

At block 3110, the process 3100 involves training a wavelet based model using a development data set of entity behaviors. Various behaviors (e.g. entity credit behaviors), model architecture, hyperparameters that define the model configuration, and training and evaluation practices may be utilized during the training.

At block 3120, the process 3100 involves creating a reference time series that represents values for each entity behavior that maximize the wavelet based model output. For example, the host computing system 102 may create a reference time series x′≡(x₁′(t), x₂′(t), . . . , xₙ′(t)) that represents values for each entity behavior that maximize the wavelet based model output. These values may be drawn from available development data so that the time series is feasible. In some instances, a time series input is represented by a series of observations at a discrete number of time points. The Shapley value approach described herein may attribute changes in a wavelet based model output to the entire time series and not a specific observation. In some examples, the Shapley value approach described herein assumes a collection of time series for n entity behaviors, x≡(x₁(t),x₂(t), . . . , xₙ(t)), and computes difference between the wavelet based model output given x and the wavelet based model output given a collection of reference time series x′:

Δy=ƒ(x)−ƒ(x′) (43)

where

x′≡(x₁′(t),x₂′(t), . . . ,xₙ′(t)) (40)

The reference time series are constant values ξᵢ over all tₖ time instances that maximize the wavelet based model output.

At block 3130, the process 3100 involves calculating Shapley values of the variables corresponding to entity behaviors. In other examples, the process 3100 involves calculating Shapley values of the variables corresponding to decomposed representations of entity behaviors. The marginal contribution of each attribute can be defined as its Shapley value.

$$I {φ}_{i} = {\sum }_{S ⊆ F ∖ \{ i \}} \frac{\vert S \vert ! ( \vert F \vert - \vert S \vert - 1 ) !}{\vert F \vert !} [ {f}_{S ⋃ \{ i \}} ( {x}_{S ⋃ \{ i \}} ) - {f}_{S} ( {x}_{S} ) ] \qquad ( 45 )$$

Shapley values can express the additive contribution of model attributes to marginal wavelet based model output:

$$f ( x ) = {φ}_{0} + {\sum }_{i = 1}^{M} {φ}_{i} {x}_{i} \qquad ( 46 )$$

In some instances, since the computation of Shapley values may be complicated because of their exponential complexity, the Shapley values can be calculated as a weighted linear regression. The sum of the Shapley values for a specific record can represent the difference between the expected value of the reference data E[ƒ(x)] and the wavelet based model output of the record. If the reference data produces a maximum output of the wavelet based model, the rank order of the Shapley values represents attributes that contribute the most to a reduction of the wavelet based model output from maximum. In some examples, in a well-constructed wavelet based model, all of the Shapley values are negative and correspond closely to the points below maximum method. In this situation, the Shapley values can produce logical and actionable adverse action codes (or reason codes) that can explain the prediction results. Traditional wavelet based models are a function of entity behaviors that are summarized in terms of input attributes (features) that are observed at a single instant in time. One class of next-generation wavelet based models considers inputs that are time series of entity behavior and identifies relationships and interactions between the entity behaviors and the output of the wavelet based model. In certain examples, a wavelet based model (e.g. credit risk model) can distinguish between low and high output values (e.g. low, high, or other degrees or values of credit risk) from time series input data.

At block 3140, the process 3100 involves associating the Shapley value contributions with entity behaviors by combining the individual contributions of basis functions or attributes upon which the behavior is dependent. In some examples, the time series may be decomposed into a combination of orthonormal basis functions, and the risk scoring function may be a composition of multiple functions. The Shapely value approach can identify the contributions of the basis functions to the wavelet based model output and then combines contributions that correspond to specific entity behaviors.

At block 3150, the process 3100 involves ranking the Shapley value contributions and identifying a predefined number of top ranked Shapley value contributions as a model explanation for the entity. For example, the host computing system 102 ranks the Shapley value contributions in descending order and identify the top M behaviors. For example, a Shapley value contribution is selected that represents the average number of inquiries over a 32 month window and the reason code provided to the customer or entity is “too many inquiries.” In other embodiments, all of the Shapley value contributions and their associated behaviors are provided as the model explanation for the entity.

Computing System Example

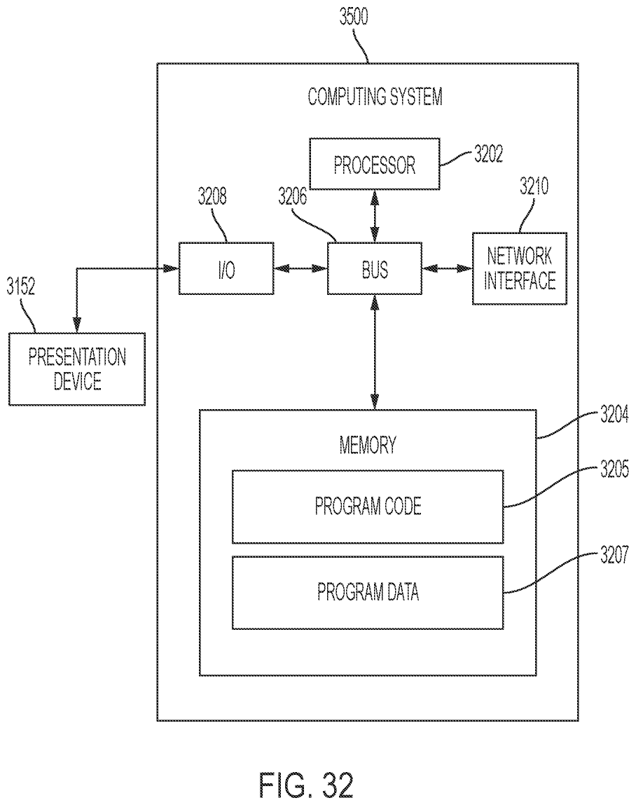

Any suitable computing system or group of computing systems can be used to perform the operations described herein. For example, FIG. 32 is a block diagram depicting an example of a computing system 3200 that can be used to implement one or more of the systems depicted in FIG. 1 (e.g., a host computing system 102, a development computing system 114, etc.). The example of the computing system 3200 can include various devices for communicating with other devices in the computing system 100, as described with respect to FIG. 1. The computing system 3200 can include various devices for performing one or more of the operations described above.

The computing system 3200 can include a processor 3202, which includes one or more devices or hardware components communicatively coupled to a memory 3204. The processor 3202 executes computer-executable program code 3205 stored in the memory 3204, accesses program data 3207 stored in the memory 3204, or both. Examples of a processor 3202 include a microprocessor, an application-specific integrated circuit, a field-programmable gate array, or any other suitable processing device. The processor 3202 can include any number of processing devices, including one. The processor 3202 can include or communicate with a memory 3204. The memory 3204 stores program code that, when executed by the processor 3202, causes the processor to perform the operations described in this disclosure.

The memory 3204 can include any suitable non-transitory computer-readable medium. The computer-readable medium can include any electronic, optical, magnetic, or other storage device capable of providing a processor with computer-readable program code or other program code. Non-limiting examples of a computer-readable medium include a magnetic disk, memory chip, optical storage, flash memory, storage class memory, a CD-ROM, DVD, ROM, RAM, an ASIC, magnetic tape or other magnetic storage, or any other medium from which a computer processor can read and execute program code. The program code may include processor-specific program code generated by a compiler or an interpreter from code written in any suitable computer-programming language. Examples of suitable programming language include C, C++, C #, Visual Basic, Java, Python, Perl, JavaScript, ActionScript, etc.

The computing system 3200 can execute program code 3205. The program code 3205 may be stored in any suitable computer-readable medium and may be executed on any suitable processing device. For example, as depicted in FIG. 32, the program code for the model-development engine 116 can reside in the memory 3204 at the computing system 3200. Executing the program code 3205 can configure the processor 3202 to perform one or more of the operations described herein.

Program code 3205 stored in a memory 3204 may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc. may be passed, forwarded, or transmitted via any suitable means including memory sharing, message passing, token passing, network transmission, among others. Examples of the program code 3205 include one or more of the applications, engines, or sets of program code described herein, such as a model-development engine 116, an interactive computing environment presented to a consumer computing system 106, timing-prediction model code 130, a predictive response application 104, etc.

Examples of program data 3207 stored in a memory 3204 may include one or more databases, one or more other data structures, datasets, etc. For instance, if a memory 3204 is a network-attached storage device 118, program data 3207 can include predictor data samples 122, response data samples, etc. If a memory 3204 is a storage device used by a host computing system 102 or a host computing system 102, program data 3207 can include predictor variable data, data obtained via interactions with consumer computing systems 106, etc.

The computing system 3200 may also include a number of external or internal devices such as input or output devices. For example, the computing system 3200 is shown with an input/output interface 3208 that can receive input from input devices or provide output to output devices. A bus 3206 can also be included in the computing system 3200. The bus 3206 can communicatively couple one or more components of the computing system 3200.

In some aspects, the computing system 3200 can include one or more output devices. One example of an output device is the network interface device 3210 depicted in FIG. 32. A network interface device 3210 can include any device or group of devices suitable for establishing a wired or wireless data connection to one or more data networks (e.g., a public data network 108, a private data network 112, etc.). Non-limiting examples of the network interface device 3210 include an Ethernet network adapter, a modem, etc. Another example of an output device is the presentation device 3212 depicted in FIG. 32. A presentation device 3212 can include any device or group of devices suitable for providing visual, auditory, or other suitable sensory output. Non-limiting examples of the presentation device 3212 include a touchscreen, a monitor, a speaker, a separate mobile computing device, etc.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

1. A computing system comprising:
a data repository storing predictor data samples including time-series values of predictor variables that respectively correspond to actions performed by an entity or observations of the entity; and
one or more processors configured for performing operations comprising:
accessing the predictor data samples in the data repository;
generating wavelet predictor variable data by, at least, applying a wavelet transform to the time-series values of the predictor variables in the predictor data samples, the wavelet predictor variable data comprising a first set of shift value input data for a first scale and a second set of shift value input data for a second scale;
computing a set of probabilities for a target event by applying a set of timing-prediction models associated with respective time windows to the first set of shift value input data and the second set of shift value input data, wherein each timing-prediction model of the set of timing-prediction models is configured to generate a respective probability of the set of probabilities indicating a probability of the target event occurring in a time window associated with the timing-prediction model;
computing an event prediction from the set of probabilities; and
causing a host system operation to be modified based on the computed event prediction.

2. The computing system of claim 1, wherein the one or more processors are further configured to perform operations comprising:
determining that the time series values of the predictor data samples are missing a time series value for at least one time instance of a time series;
setting the time series value for the at least one time instance to zero;
generating a missing value indicator for the time series, the missing value indicator having a value of zero for the at least one time instance and a value of one for other time instances of the time series; and
based on the missing value indicator and the wavelet predictor variable data, calculating confidence values that correspond to wavelet coefficients for the time series data, wherein the wavelet variable predictor data further comprise the confidence values.

3. The computing system of claim 1, wherein the one or more processors are further configured to generate explanatory data for the event prediction.

4. The computing system of claim 3, wherein the one or more processors are configured to generate the explanatory data by:
determining a set of wavelet values of the wavelet predictor variable data that, when the set of timing-prediction models is applied to the wavelet values, result in a maximum value for the event prediction;
computing, for a wavelet of the wavelet predictor variable data, a points lost value as a difference between the maximum value and a value of the event prediction generated by replacing the wavelet in the set of wavelet values with a current value of the wavelet; and
generating explanatory data for the prediction based, at least in part, upon the points lost value for the wavelet.

5. The computing system of claim 4, wherein the wavelet transform comprises a set of wavelets, wherein the wavelet predictor variable data is generated by, at least, applying the set of wavelets of the wavelet transform to the predictor data samples, and wherein the wavelet values of the wavelet predictor variable data correspond to the set of wavelets.

6. The computing system of claim 3, wherein the one or more processors are configured to generate the explanatory data by:
determining an optimal set of time-series values associated with an optimum event prediction;
evaluating an integrated gradients calculation along a path in attribute space from the optimal set of time-series values to the set of time series values;
determining an allocation of change between the event prediction and the optimum event prediction for each of the set of time-series values by summing integrated gradients for each of the set of time-series values; and
selecting one or more of the determined allocations as an explanation for the event prediction.

7. The computing system of claim 3, wherein the one or more processors are configured to generate explanatory data by:
training the set of timing-prediction models using a data set of entity behaviors;
determining an optimal set of time-series values associated with an optimum event prediction;
calculating, for each of the values of the set of time-series values, a Shapley value contribution;
associating the Shapley value contributions with entity behaviors by combining, for each entity behavior, individual contributions of attributes upon which the entity behavior is dependent; and
selecting one or more entity behaviors having a greatest Shapley value contribution as an explanation of the event prediction.

8. A method comprising:
accessing, by a computing device, predictor data samples that comprise time-series values of predictor variables that respectively correspond to actions performed by an entity or observations of the entity;
generating, by the computing device, wavelet predictor variable data by, at least, applying a wavelet transform to the time-series values of the predictor variables in the predictor data samples, the wavelet predictor variable data comprising a first set of shift value input data for a first scale and a second set of shift value input data for a second scale;
computing a set of probabilities for a target event by applying a set of timing-prediction models associated with respective time windows to the first set of shift value input data and the second set of shift value input data, wherein each timing-prediction model of the set of timing-prediction models is configured to generate a respective probability of the set of probabilities indicating a probability of the target event occurring in a time window associated with the timing-prediction model;
computing, by the computing device, an event prediction from the set of probabilities, and
causing, by a computing device, a host system operation to be modified based on the computed event prediction.

9. The method of claim 8, further comprising:
determining that the time series values of the predictor data samples are missing a time series value for at least one time instance of a time series;
setting the time series value for the at least one time instance to zero;
generating a missing value indicator for the time series, the missing value indicator having a value of zero for the at least one time instance and a value of one for other time instances of the time series; and
calculating, based on the missing value indicator and the wavelet predictor variable data, confidence values that correspond to wavelet coefficients for the time series data, wherein the wavelet variable predictor data further comprise the confidence values.

10. The method of claim 8, further comprising generating explanatory data for the event prediction.

11. The method of claim 10, wherein generating the explanatory data comprises:
determining a set of wavelet values of the wavelet predictor variable data that, when the set of timing-prediction models is applied to the wavelet values, result in a maximum value for the event prediction;
compute, for a wavelet of the wavelet predictor variable data, a points lost value as a difference between the maximum value and a value of the event prediction generated by replacing the wavelet in the set of wavelet values with a current value of the wavelet; and
generating explanatory data for the prediction based, at least in part, upon the points lost value for the wavelet.

12. The method of claim 11, wherein the wavelet transform comprises a set of wavelets, wherein the wavelet predictor variable data is generated by, at least, applying the set of wavelets of the wavelet transform to the predictor data samples, and wherein the wavelet values of the wavelet predictor variable data correspond to the set of wavelets.

13. The method of claim 10, wherein generating the explanatory data comprises:
determining an optimal set of time-series values associated with an optimum event prediction;
evaluating an integrated gradients calculation along a path in attribute space from the optimal set of time-series values to the set of time series values;
determining an allocation of change between the event prediction and the optimum event prediction for each of the set of time-series values by summing integrated gradients for each of the set of time-series values; and
selecting one or more of the determined allocations as an explanation for the event prediction.

14. The method of claim 10, wherein generating the explanatory data comprises:
training the set of timing-prediction models using a data set of entity behaviors;
determining an optimal set of time-series values associated with an optimum event prediction;
calculating, for each of the values of the set of time-series values, a Shapley value contribution;
associating the Shapley value contributions with entity behaviors by combining, for each entity behavior, individual contributions of attributes upon which the entity behavior is dependent; and
selecting one or more entity behaviors having a greatest Shapley value contribution as an explanation of the event prediction.

15. A non-transitory computer-readable medium, comprising computer-executable program instructions that, when executed by a processor, cause the processor to perform operations comprising:
accessing predictor data samples that comprise time-series values of predictor variables that respectively correspond to actions performed by an entity or observations of the entity;
generating wavelet predictor variable data by, at least, applying a wavelet transform to the time-series values of the predictor variables in the predictor data samples, the wavelet predictor variable data comprising a first set of shift value input data for a first scale and a second set of shift value input data for a second scale;
computing a set of probabilities for a target event by applying a set of timing-prediction models associated with respective time windows to the first set of shift value input data and the second set of shift value input data, wherein each timing-prediction model of the set of timing-prediction models is configured to generate a respective probability of the set of probabilities indicating a probability of the target event occurring in a time window associated with the timing-prediction model;
computing an event prediction from the set of probabilities, and
causing a host system operation to be modified based on the computed event prediction.

16. The non-transitory computer readable medium of claim 15, wherein the operations further comprise:
determining that the time series values of the predictor data samples are missing a time series value for at least one time instance of a time series;
setting the time series value for the at least one time instance to zero;
generating a missing value indicator for the time series, the missing value indicator having a value of zero for the at least one time instance and a value of one for other time instances of the time series; and
calculating, based on the missing value indicator and the wavelet predictor variable data, confidence values that correspond to wavelet coefficients for the time series data, wherein the wavelet variable predictor data further comprise the confidence values.

17. The non-transitory computer readable medium of claim 15, wherein the operations further comprise:
determining a set of wavelet values of the wavelet predictor variable data that, when the set of timing-prediction models is applied to the wavelet values, result in a maximum value for the event prediction;
computing, for a wavelet of the wavelet predictor variable data, a points lost value as a difference between the maximum value and a value of the event prediction generated by replacing the wavelet in the set of wavelet values with a current value of the wavelet; and
generating explanatory data for the prediction based, at least in part, upon the points lost value for the wavelet.

18. The non-transitory computer readable medium of claim 17, wherein the wavelet transform comprises a set of wavelets, wherein the wavelet predictor variable data is generated by, at least, applying the set of wavelets of the wavelet transform to the predictor data samples, and wherein the wavelet values of the wavelet predictor variable data correspond to the set of wavelets.

19. The non-transitory computer readable medium of claim 17, wherein the operations further comprise:
determining an optimal set of time-series values associated with an optimum event prediction;
evaluating an integrated gradients calculation along a path in attribute space from the optimal set of time-series values to the set of time series values; and
determining an allocation of change between the event prediction and the optimum event prediction for each of the set of time-series values by summing integrated gradients for each of the set of time-series values; and
select one or more of the determined allocations as an explanation for the event prediction.

20. The non-transitory computer readable medium of claim 15, wherein the operations further comprise:
training the set of timing-prediction models using a data set of entity behaviors;
determining an optimal set of time-series values associated with an optimum event prediction;
calculating, for each of the values of the set of time-series values, a Shapley value contribution;
associating the Shapley value contributions with entity behaviors by combining, for each entity behavior, individual contributions of attributes upon which the entity behavior is dependent; and
selecting one or more entity behaviors having a greatest Shapley value contribution as an explanation of the event prediction.
